(19) United States
(12) Patent Application Publication
(10) Pub. No.: US 2026/0328044 A1
(43) Pub. Date: Oct. 22, 2026

(54) REFRIGERATOR

(71) Applicant: SAMSUNG ELECTRONICS CO., LTD., Suwon-si (KR)

(72) Inventors: Taecheol PARK, Suwon-si (KR); Changgu KANG, Suwon-si (KR); Ilsung BAE, Suwon-si (KR); Byoungjae CHO, Suwon-si (KR); Seunghyeok SON, Suwon-si (KR); Sehyeon BAEK, Suwon-si (KR); Hosang PARK, Suwon-si (KR)

(73) Assignee: SAMSUNG ELECTRONICS CO., LTD., Suwon-si (KR)

(21) Appl. No.: 19/649,974

(22) Filed: Apr. 16, 2026

Related U.S. Application Data
(63) Continuation of application No. PCT/KR2026/005301, filed on Apr. 10, 2026.

(30) Foreign Application Priority Data
Apr. 18, 2025 (KR) 10-2025-0051172
Aug. 4, 2025 (KR) 10-2025-0107094

(51) Int. Cl. E05F 15/73; F25D 23/02

(52) U.S. Cl. CPC E05F 15/73; F25D 23/028; E05Y 2900/31; F25D 2323/023

(57) ABSTRACT

A refrigerator includes a main body having a storage compartment, a door configured to be rotatable to open or close the storage compartment, a controller included in the main body, a sensor disposed at a lower portion of the door to and an electric wire electrically connected to the sensor and the controller, respectively, and being withdrawn from the main body and passing through inside of the door. The door includes an accommodating space, an insulation panel disposed in the accommodating space, a perimeter region included in the accommodating space, and formed between an outer side of the insulation panel and an inner side of the door along a perimeter of the door, and an electric wire fixing part to guide the electric wire to be bent at a corner of the perimeter region and extend along the perimeter region.

### CROSS REFERENCE TO THE RELATED APPLICATION

This application is a continuation application, filed under 35 U.S.C. § 111(a), of International Application PCT/KR2026/005301 filed Apr. 10, 2026, and is based on and claims priority under 35 U.S.C. § 119 to Korean Patent Applications No. 10-2025-0051172, filed on Apr. 18, 2025 and Korean Patent Applications No. 10-2025-0107094, filed on Aug. 4, 2025 and in the Korean Intellectual Property Office, the disclosures of which are incorporated by reference herein in their entireties.

### TECHNICAL FIELD

The present disclosure relates to a refrigerator having an improved structure.

### BACKGROUND ART

A refrigerator is a home appliance keeping food fresh by including a main body having a storage compartment and a cold air supply device provided to supply cold air to the storage compartment, a door provided to open and close the storage compartment.

A refrigerator door may be provided to open and close a storage compartment by rotating around a rotation axis. Additionally, a refrigerator may include an opening/closing device and a sensor for opening and closing the door.

Electric wires connected to an opening/closing device and/or a sensor may be provided inside a refrigerator door.

A refrigerator door may include an inner door having an opening and rotatably connected to a main body, and an outer door provided to be rotatable relative to the inner door to open and close the opening of the inner door.

### DISCLOSURE

### Technical Problem

The present disclosure is directed to providing a refrigerator configured such that an electric wire inside a refrigerator door is arranged to bypass an insulation panel.

The present disclosure is directed to providing a refrigerator having a wire fixing part provided inside a refrigerator door.

The present disclosure is directed to providing a refrigerator in which a wire fixing part is provided in a door cap of a refrigerator door.

Technical tasks to be achieved in this document are not limited to the technical tasks mentioned above, and other technical tasks not mentioned will be clearly understood by those skilled in the art from the description below.

### Technical Solution

A refrigerator according to an embodiment of the present disclosure may include: a main body having a storage compartment; a door configured to be rotatable on the main body to open and close the storage compartment; a sensor unit provided on a lower portion of the door to recognize external information; and an electric wire electrically connected to the sensor unit by being withdrawn from the main body and passing through the inside of the door, wherein the door may include: an insulation panel provided on a central portion inside the door; a perimeter region provided inside the door to be provided along a perimeter of the door on the outside of the insulation panel; and an electric wire fixing part provided to guide the electric wire to be bent at a corner of the perimeter region and extend along the perimeter region.

A refrigerator according to an embodiment of the present disclosure may include: a main body having a storage compartment; an inner door rotatably coupled to the front of the main body and including an opening; and an outer door rotatably coupled to the front of the inner door to open and close the opening, wherein the outer door may include: an insulation panel disposed on a central portion inside the outer door; a perimeter region provided on an outer side of an edge of the insulation panel along a perimeter of the outer door; an electric wire arranged to extend along the inside of the outer door to be electrically connected to a sensor unit disposed on a lower portion of the outer door; and an electric wire fixing part provided to guide the electric wire to be bent at a corner of the perimeter region and extend along the perimeter region, and the electric wire may be provided to bypass the insulation panel and extend along the perimeter region.

A refrigerator according to an embodiment of the present disclosure may include: a main body having a storage compartment; a double door including an inner door and an outer door rotatably coupled to each other through a hinge; and a sensor unit coupled to a lower portion of the outer door to recognize external information, wherein the hinge may include a hinge plate fixed to the inner door and a hinge shaft rotatably inserted into an insertion hole of the outer door, a passing hole of a closed shape through which an electric wire penetrates in an up-down direction may be formed in the hinge plate, and a shaft groove extending to an end of the hinge shaft may be formed on an outer circumferential surface of the hinge shaft, so that the electric wire may pass through the passing hole, be withdrawn into the inside of the outer door along the shaft groove, extend along a perimeter region of the outer door, pass through the inside of the outer door, and be electrically connected to the sensor unit.

A refrigerator may include a main body having a storage compartment, a door configured to be rotatable with respect to the main body to open or close the storage compartment, a controller included in the main body, and configured to control the door to open or close, a sensor disposed at a lower portion of the door to detect external information and transmit a signal including the detected external information to the controller so that the controller controls the door to open or close based on the transmitted signal, and an electric wire electrically connected to the sensor and the controller, respectively, to transmit the signal to the controller, the electric wire being withdrawn from the main body and passing through inside of the door.

The door may comprises an accommodating space therein, an insulation panel disposed in the accommodating space, a perimeter region included in the accommodating space, and formed between an outer side of the insulation panel and an inner side of the door along a perimeter of the door, and an electric wire fixing part to guide the electric wire to be bent at a corner of the perimeter region and extend along the perimeter region.

The door comprises a front plate forming a front surface of the door, a rear plate forming a rear surface of the door, the insulation panel disposed between the front plate and the rear plate, a door liner forming a portion of the rear surface of the door, a plurality of side chassis forming opposite side surfaces of the door, an upper door cap forming an upper surface of the door, and a lower door cap forming a lower surface of the door.

The accommodating space may be formed by the front plate, the rear plate, the door liner, the plurality of side chassis, the upper door cap, and the lower door cap.

The electric wire may be arranged to be bent on the electric wire fixing part and to extend along a first section of the perimeter region from the electric wire fixing part toward one side in a perimeter direction of the door and a second section of the perimeter region from the electric wire fixing part toward an other side in the perimeter direction of the door.

The electric wire extended in the first section may be positioned between outside of the door and the electric wire fixing part, and the electric wire extended in the second section may be positioned between the electric wire fixing part and the sensor.

The electric wire may be disposed between inner side surfaces of the plurality of side chassis and outer side surfaces of the insulation panel.

The electric wire fixing part may be on one side of the lower door cap adjacent to a rotation axis of the door, and comprises a lower guide rib formed to protrude in an inside direction of the door from the lower door cap.

The lower guide rib may be spaced apart from a wall of the lower door cap to form a first electric wire guide gap, and the electric wire may be fixed in the first electric wire guide gap.

An outer side surface of the lower guide rib may comprise a flat portion to face the wall forming the first electric wire guide gap, and a curved portion disposed on an opposite side of the flat portion.

The lower guide rib may comprise a fastening hole open toward a lower side of the lower door cap so that a screw is fastened on the lower side of the lower door cap.

The electric wire fixing part may be on a side opposite to one side of the upper door cap adjacent to a rotation axis of the door, and comprise an upper guide rib assembly to form a first electric wire guide gap with one surface of the upper door cap.

The upper guide rib assembly may comprise a first rib extending to be spaced apart from a front surface of the upper door cap, a second rib to connect one end of the first rib and the front surface of the upper door cap, and a rib cap to be assembled to an other end of the first rib to cover a gap between the other end of the first rib and the front surface of the upper door cap.

The electric wire may be fixed between the first rib and the front surface of the upper door cap.

The rib cap may be integrally injected with the upper door cap and then separated and assembled to the other end of the first rib.

The refrigerator according may further comprise an inner door configured to be rotated in a front of the main body, the inner door comprising an opening, and a hinge disposed on the inner door to be rotatably coupled to the door, the hinge may comprise a hinge plate coupled to the inner door and having a passing hole of a closed shape formed therein so that the electric wire passes therethrough in an up-down direction, and a hinge shaft inserted into an insertion hole communicating with the inside of the door.

The door may further comprise an outer door configured to be rotated in front of the inner door to open or close the opening.

A shaft groove extending in a shaft direction to an end of the hinge shaft may be formed on an outer circumferential surface of the hinge shaft so that the electric wire passed through the passing hole is to be withdrawn into the inside of the outer door along the shaft groove.

A refrigerator may a main body having a storage compartment, a double door configured to be rotatable with respect to the main body to open or close the storage compartment, the double door comprising an outer door, an inner door rotatably coupled to the outer door, a controller included in the main body, and configured to control the double door to open or close, a sensor coupled to a lower portion of the outer door to detect external information and transmit a signal including the detected external information to the controller so that the controller controls the double door to open or close based on the transmitted signal, an electric wire electrically connected to the sensor and the controller, respectively, to transmit the signal to the controller.

The outer door may include a hinge insertion hole, an accommodating space therein, an insulation panel disposed in the accommodating space, a perimeter region included in the accommodating space, and formed between an outer side of the insulation panel and an inner side of the outer door along a perimeter of the outer door, and an electric wire fixing part to guide the electric wire to be bent at a corner of the perimeter region and extend along the perimeter region, and the inner door may include a hinge to be rotatably coupled to the outer door. The hinge may include a hinge plate coupled to the inner door and having a passing hole for the electric wire to pass therethrough, and a hinge shaft rotatably inserted into the hinge insertion hole to communicate with inside of the outer door so that the electric wire from the controller passes through the passing hole, extends along the perimeter region of the outer door, passes through the inside of the outer door, and be electrically connected to the sensor.

### DESCRIPTION OF DRAWINGS

FIG. 1 is a perspective view illustrating a refrigerator according to an embodiment of the present disclosure.

FIG. 2 is a perspective view illustrating the refrigerator in which an outer door is opened according to an embodiment of the present disclosure.

FIG. 3 is a perspective view illustrating the refrigerator in which all doors are opened according to an embodiment of the present disclosure.

FIG. 4 is a perspective view illustrating a door according to an embodiment of the present disclosure.

FIG. 5 is a perspective view illustrating a state in which the outer door is opened in the door according to an embodiment of the present disclosure.

FIG. 6 is a perspective view illustrating a state in which the outer door and an inner door are separated according to an embodiment of the present disclosure.

FIG. 7 is an exploded perspective view of the outer door according to an embodiment of the present disclosure.

FIG. 8 is an exploded perspective view of the outer door according to an embodiment of the present disclosure.

FIG. 9 is an enlarged view illustrating a state in which the inner door and the outer door are separated in a region corresponding to region A in FIG. 5 according to an embodiment of the present disclosure.

FIG. 10 is a view illustrating a state in which some components of the inner door are separated according to an embodiment of the present disclosure.

FIG. 11 is a view illustrating a state in which some components of the door are separated according to an embodiment of the present disclosure.

FIG. 12 is a rear view of the outer door for explaining arrangement of an electric wire inside the outer door according to an embodiment of the present disclosure.

FIG. 13 is a perspective view illustrating some components of the outer door according to an embodiment of the present disclosure.

FIG. 14 is a cross-sectional view of the outer door cut along line B-B′ in FIG. 12 according to an embodiment of the present disclosure.

FIG. 15 is a rear view of the outer door for explaining arrangement of an electric wire inside the outer door according to an embodiment of the present disclosure.

FIG. 16 is a cross-sectional view of the outer door cut along line C-C′ in FIG. 15 according to an embodiment of the present disclosure.

FIG. 17 is an enlarged view illustrating a state in which some components of the outer door are separated in a region corresponding to region D in FIG. 15 according to an embodiment of the present disclosure.

FIG. 18 is a perspective view illustrating some components of the outer door according to an embodiment of the present disclosure.

FIG. 19 is an exploded view illustrating some components of the outer door according to an embodiment of the present disclosure.

FIG. 20 is a rear view of the outer door for explaining arrangement of the electric wire inside the outer door according to an embodiment of the present disclosure.

FIG. 21 is a cross-sectional view of the outer door cut along line E-E′ in FIG. 20 according to an embodiment of the present disclosure.

FIG. 22 is a perspective view illustrating some components of the outer door from the front according to an embodiment of the present disclosure.

FIG. 23 is a front view illustrating some components of the outer door according to an embodiment of the present disclosure.

FIG. 24 is an enlarged perspective view illustrating region F in FIG. 23 from the rear in the outer door according to an embodiment of the present disclosure.

### MODE OF THE DISCLOSURE

Various embodiments of the present disclosure and the terms used therein are not intended to limit the technical features described in the present disclosure to specific embodiments, and should be understood to include various modifications, equivalents, or substitutes of the embodiments.

In connection with the explanation of the drawings, like reference numbers may be used for like or related components.

The singular form of a noun corresponding to an item may include one item or a plurality of items, unless the relevant context clearly dictates otherwise.

In the present disclosure, each of phrases such as “A or B,” “at least one of A and B,” “at least one of A or B,” “A, B or C,” “at least one of A, B and C,” and “at least one of A, B, or C” may include any one of the items listed together in the corresponding one of the phrases, or all possible combinations thereof.

The term “and/or” includes any combination of a plurality of related components or any one of a plurality of related components.

Terms such as “first,” “second,” “primary,” and “secondary” may simply be used to distinguish a given component from other corresponding components, and do not limit the corresponding components in any other aspect (e.g., importance or order).

In the present disclosure, the terms “front surface,” “rear surface,” “upper surface,” “lower surface,” “side surface,” “left side,” “right side,” “upper portion,” and “lower portion” used in the following description are defined based on the drawings, and the shape and position of each component are not limited by these terms.

The terms “includes” and “has” are intended to indicate that there are features, numbers, steps, operations, components, parts, or combinations thereof described in the present disclosure, and do not exclude the presence or addition of one or more other features, numbers, steps, operations, components, parts, or combinations thereof.

When a certain component is referred to as being “connected to”, “coupled to”, “supported by” or “in contact with” another component, this includes a case in which the components are indirectly connected to, coupled to, supported by, or in contact with each other through a third component as well as directly connected to, coupled to, supported by, or in contact with each other.

When any component is referred to as being located “on” or “above” another component, this includes not only a case in which any component is in contact with another component but also a case in which another component is present between the two components.

A refrigerator according to an embodiment may include a main body.

The “main body” may include an inner case, an outer case disposed on the outside of the inner case, and an insulator provided between the inner case and the outer case.

The “inner case” may include at least one of a case, a plate, a panel and a liner forming a storage compartment. The inner case may be formed as a single body or may be formed by assembling a plurality of plates. The “outer case” may form an outer appearance of the main body and may be coupled to the outside of the inner case so that the insulator is disposed between the inner case and the outer case.

The “insulator” may insulate the inside and outside of the storage compartment so that a temperature inside the storage compartment may be maintained at a set appropriate temperature without being affected by an external environment of the storage compartment. According to an embodiment, the insulator may include a foam insulator such as polyurethane foam. A foam insulator may be formed by injecting and foaming urethane foam mixed with polyurethane and foaming agent between the inner case and the outer case.

According to an embodiment, the insulator may further include a vacuum insulator in addition to the foam insulator, or may be configured as only the vacuum insulator instead of the foam insulator. The vacuum insulator may include a core material and an outer shell material that accommodates the core material and seals the inside thereof with a vacuum or a pressure close to vacuum. However, the insulator is not limited to the foam insulator or vacuum insulator described above and may include various materials that may be used for insulation.

The “storage compartment” may include a space defined by the inner case. The storage compartment may further include an inner case defining a space corresponding to the storage compartment. The storage compartment may store various items such as food, medicine, and cosmetics, and may be formed such that at least one side thereof is open to allow items to be put in and to be taken out.

The refrigerator may include one or more storage compartments. When two or more storage compartments are formed in the refrigerator, the respective storage compartments may have different uses and may be maintained at different temperatures. To this end, the respective storage compartments may be partitioned from each other by partitions including the insulators.

The storage compartment may be provided to be maintained at an appropriate temperature range depending on the use, and may include a “refrigerating chamber,” a “freezing chamber,” or a “variable temperature chamber” depending on the use and/or temperature range. The refrigerating chamber may be maintained at an appropriate temperature for storing items in a refrigerated state, and the freezing chamber may be maintained at an appropriate temperature for storing items in a frozen state. “Refrigerating” may refer to cooling items to the point where the items are not frozen, and as an example, the refrigerating chamber may be maintained in a temperature ranging from zero degree Celsius to seven degrees Celsius. “Freezing” may refer to cooling items such that the items are freezing or maintained in a frozen state, as an example, the freezing chamber may be maintained at a temperature ranging from minus twenty degrees Celsius to minus one degree Celsius. The variable temperature chamber may be used as any one of the refrigerating chamber and the freezing chamber, depending on a selection of a user or regardless of the selection of the user.

In addition to names such as “refrigerating chamber,” “freezing chamber,” and “variable temperature chamber,” the storage compartment may be referred to as various names such as “vegetable chamber,” “fresh chamber,” “cooling chamber,” and “ice making chamber,” terms such as “refrigerating chamber,” “freezing chamber,” and “variable temperature chamber” used below should be understood to encompass storage compartments with corresponding uses and temperature ranges, respectively.

According to an embodiment, the refrigerator may include at least one door configured to open and close the one open side of the storage compartment. The doors may each be provided to open and close the one or more storage compartments, or the one door may be provided to open and close a plurality of the storage compartments. The door may be rotatably or slidingly installed on a front side of the main body.

The “door” may be configured to seal the storage compartment when closed. Like the main body, the door may include the insulator to insulate the storage compartment when closed.

According to an embodiment, the door may include a door outer plate forming a front surface of the door, a door inner plate forming a rear surface of the door and facing the storage compartment, an upper cap, a lower cap, and a door insulator provided inside the upper and lower caps.

Edges of the door inner plate may be provided with a gasket sealing the storage compartment by coming into close contact with the front side of the main body when the door is closed. The door inner plate may include a dyke protruding rearward so that a door basket for storing items is mounted.

According to an embodiment, the door may include a door body, and a front panel detachably coupled to a front side of the door body and forming the front surface of the door. The door body may include the door outer plate forming a front surface of the door body, the door inner plate forming a rear surface of the door body and facing the storage compartment, the upper cap, the lower cap, and the door insulator provided inside the upper and lower caps.

Refrigerators may be classified into a French door type, a side-by-side type, a bottom mounted freezer (BMF) type, a top mounted freezer (TMF) type, and a one-door refrigerator type depending on the arrangement of doors and storage compartments.

According to an embodiment, the refrigerator may include a cold air supply device configured to supply cold air to the storage compartment.

The “cold air supply device” may include a machine, mechanism, electronic device, and/or a system combining them capable of generating cold air and guiding the cold air to cool the storage compartment.

According to an embodiment, the cold air supply device may generate cold air through a refrigeration cycle including compression, condensation, expansion, and evaporation processes of a refrigerant. To this end, the cold air supply device may include a refrigeration cycle device having a compressor, a condenser, an expansion device, and an evaporator capable of driving the refrigeration cycle. According to an embodiment, the cold air supply device may include a semiconductor such as a thermoelectric element. The thermoelectric element may cool the storage compartment by generating heat and cooling through the Peltier effect.

According to an embodiment, the refrigerator may include a machine room in which at least some components belonging to the cold air supply device are disposed.

The “machine room” may be provided to be partitioned and insulated from the storage compartment in order to prevent heat generated from the components disposed in the machine room from being transferred to the storage compartment. The inside of the machine room may be configured to communicate with the outside of the main body to dissipate heat from the components disposed inside the machine room.

According to an embodiment, the refrigerator may include a dispenser provided on the door to provide water and/or ice. The dispenser may be provided on the door such that the user may access the door without opening the door.

According to an embodiment, the refrigerator may include an ice making device provided to produce ice. The ice making device may include an ice making tray provided to store water, an ice moving device provided to separate the ice from the ice making tray, and an ice bucket provided to store the ice produced in the ice making tray.

According to an embodiment, the refrigerator may include a controller configured to control the refrigerator.

The “controller” may include memory provided to store or remember programs and/or data for controlling the refrigerator, and a processor provided to output a control signal for controlling the cold air supply device and the like according to the programs and/or data stored in the memory.

The memory stores or records a variety of information, data, commands, programs, and the like required for operations of the refrigerator. The memory may remember temporary data generated while generating control signals for controlling components included in the refrigerator. The memory may include at least one of volatile memory and non-volatile memory, or a combination thereof.

The processor controls the overall operation of the refrigerator. The processor may control the components of the refrigerator by executing the programs stored in the memory. The processor may include a separate NPU to perform operations of an artificial intelligence model. The processor may also include a central processor, a graphics processor (GPU), and the like. The processor may generate a control signal for controlling an operation of the cold air supply device. For example, the processor may receive temperature information of the storage compartment from a temperature sensor, and generate a cooling control signal for controlling the operation of the cold air supply device based on the temperature information of the storage compartment.

Additionally, the processor may process user input of a user interface according to the programs and/or data memorized/stored in the memory and control an operation of the user interface. The user interface may be provided using an input interface and an output interface. The processor may receive the user input from the user interface. The processor may also transmit a display control signal and image data for displaying an image on the user interface to the user interface in response to the user input.

The processor and the memory may be provided integrally or may be provided separately. The processor may include one or more processors. For example, the processor may include a main processor and at least one sub-processor. The memory may include one or more memories.

According to an embodiment, the refrigerator may include a processor and a memory to control all the components included in the refrigerator, and may include a plurality of processors and a plurality of memories to individually control the components of the refrigerator. For example, the refrigerator may include a processor and memory to control the operation of the cold air supply device depending on output of the temperature sensor. Also, the refrigerator may be separately equipped with a processor and memory to control the operation of the user interface according to user input.

A communication module may communicate with an external device such as a server, a mobile device, and another home appliance through a nearby access point (AP). The access point (AP) may connect a local area network (LAN) to which the refrigerator or a user device is connected to a wide area network (WAN) to which the server is connected. The refrigerator or the user device may be connected to the server via the wide area network (WAN).

The input interface may include a key, a touch screen, a microphone, and the like. The input interface may receive user input and transmit the user input to the processor.

The output interface may include a display, a speaker, and the like. The output interface may output various notifications, messages, a variety of information, and the like generated by the processor.

The terms “forward and rearward directions,” “left and right directions,” “upward,” “downward,” and the like used in the following description are defined based on the drawings, and a shape and position of each component are not limited by these terms.

For example, an X direction may be defined as a front-rear direction. For example, a Y direction may be defined as a left-right direction. For example, a Z direction may be defined as an up-down direction. For example, a +X direction may be defined as a forward direction, and a −X direction may be defined as a rearward direction. For example, a +Y direction may be defined as a left direction, and a −Y direction may be defined as a right direction. For example, a +Z direction may be defined as an upward direction, and a −Z direction may be defined as a downward direction. In addition, the front-rear direction, left-right direction, and the up-down direction may each be defined based on a case in which both an inner door 100 and an outer door 200 of a refrigerator 1, which will be described later, are closed, and hereinafter, it will be described assuming that both the inner door 100 and the outer door 200 of the refrigerator 1 are closed.

Hereinafter, embodiments of the present disclosure will be described in detail with reference to the accompanying drawings.

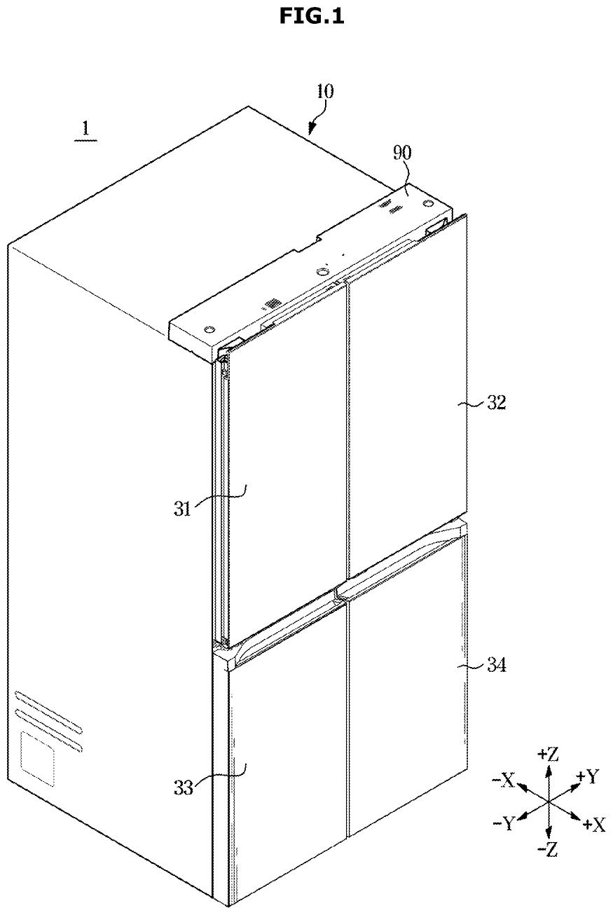

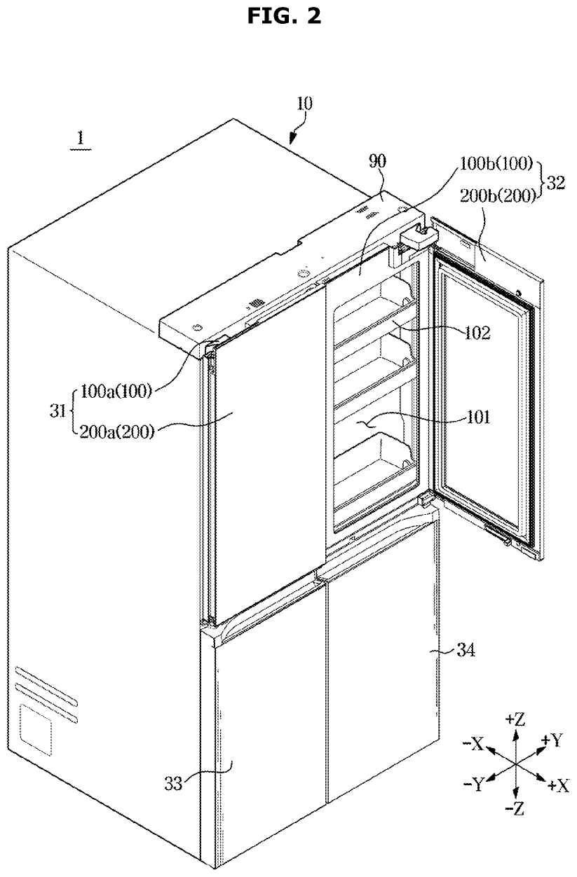

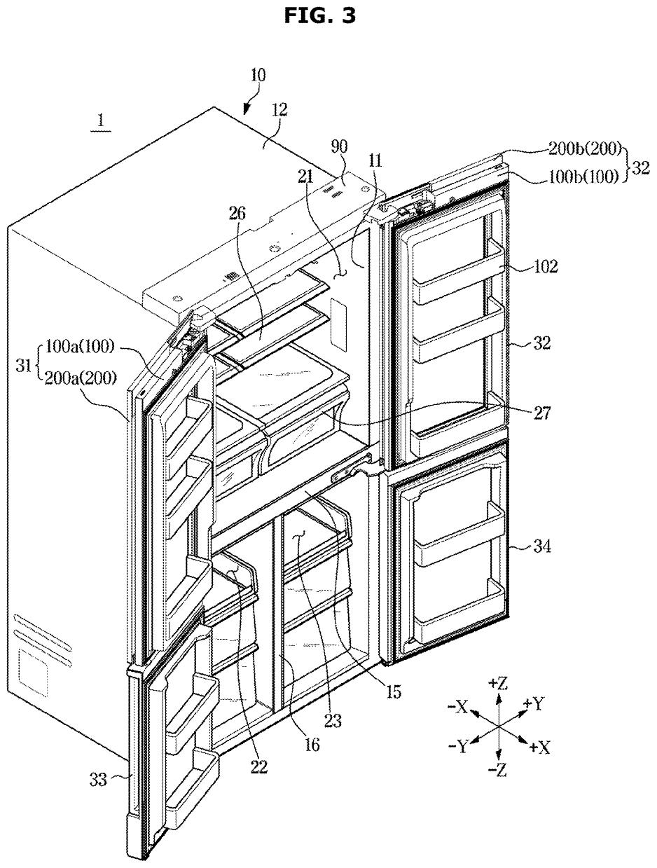

FIG. 1 is a perspective view illustrating a refrigerator according to an embodiment of the present disclosure. FIG. 2 is a perspective view illustrating the refrigerator in which an outer door is opened according to an embodiment of the present disclosure. FIG. 3 is a perspective view illustrating the refrigerator in which all doors are opened according to an embodiment of the present disclosure.

Referring to FIGS. 1 to 3, the refrigerator 1 may include a main body 10, storage compartments 21, 22, and 23 formed inside the main body 10, doors 31, 32, 33, and 34 configured to open and close the storage compartments 21, 22, and 23, and a cold air supply device (not shown) configured to supply cold air to the storage compartments 21, 22, and 23.

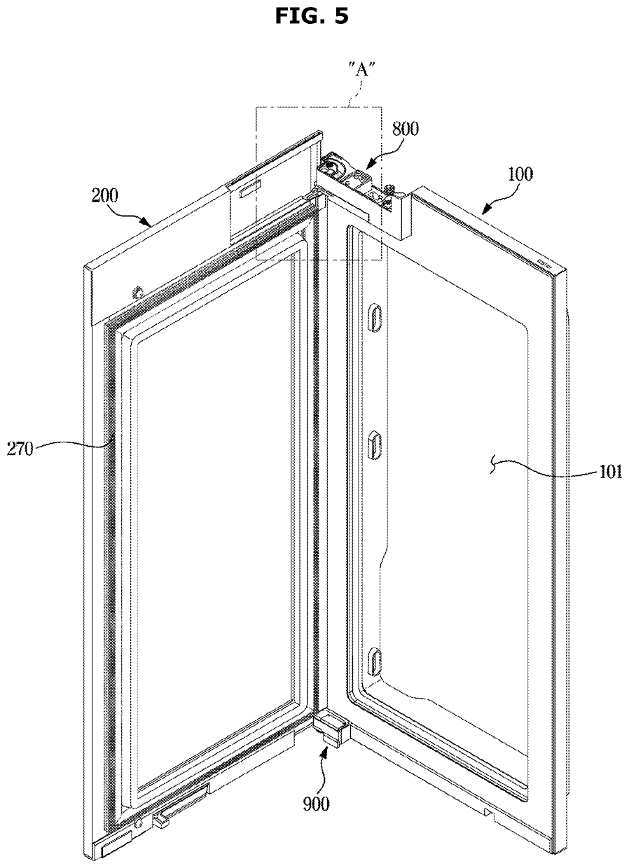

The main body 10 may include an inner case 11 forming the storage compartments 21, 22, and 23, an outer case 12 coupled to the outside of the inner case 11 to form an outer appearance, and an insulator (not shown) provided between the inner case 11 and the outer case 12 to insulate the storage compartments 21, 22, and 23. A top cover 90 may be provided on an upper surface of the main body 10 to cover an upper hinge device 800 (see FIG. 5), which will be described later.

The storage compartments 21, 22, and 23 may be partitioned in plurality by a horizontal partition wall 15 and a vertical partition wall 16. The storage compartments 21, 22, and 23 may be partitioned into the upper storage compartment 21 and the lower storage compartments 22 and 23 by the horizontal partition wall 15, and the lower storage compartments 22 and 23 may be partitioned into the left lower storage compartment 22 and the right lower storage compartment 23 by the vertical partition wall 16.

The upper storage compartment 21 may be used as a refrigerating compartment, and the lower storage compartments 22 and 23 may be used as freezing compartments. However, the division and use of the storage compartments 21, 22, and 23 as described above is only an example and is not limited thereto.

In addition, unlike this embodiment, the refrigerator may be a side by side (SBS) type in which the storage compartment is partitioned into left and right sides by a vertical partition, a French door refrigerator (FDR) type in which the storage compartment is partitioned into an upper refrigerating compartment and a lower refrigerating compartment by a horizontal partition wall, or a one-door type having one storage compartment and one door.

Inside the storage compartments 21, 22, and 23, shelves 26 and storage containers 27 may be provided.

The cold air supply device may generate cold air using a cooling circulation cycle in which a refrigerant is compressed, condensed, expanded, and evaporated, and supply the generated cold air to the storage compartments 21, 22, and 23.

The upper storage compartment 21 may be opened and closed by a pair of the doors 31 and 32. The pair of doors 31 and 32 may be rotatably coupled to the main body 10. A pair of the doors 31 and 32 may include the upper left door 31 and the upper right door 32.

One of the pair of doors 31 and 32 may be provided with a rotating bar (not shown) to prevent cold air from the storage compartment 21 from leaking between the pair of doors 31 and 32 when the pair of doors 31 and 32 is closed.

The lower left storage compartment 22 may be opened and closed by the lower left door 33, and the lower left door 33 may be rotatably coupled to the main body 10. The lower right storage compartment 23 may be opened and closed by the lower right door 34, and the lower right door 34 may be rotatably coupled to the main body 10.

At least one of the doors 31, 32, 33, and 34 may be configured as a double door having an inner door and an outer door. As an example, the upper left door 31 may include an inner door 100a and an outer door 200a. As an example, the upper right door 32 may include an inner door 100b and an outer door 200b.

However, the present disclosure is not limited thereto. For example, each of the lower left door 33 and the lower right door 34 may be configured as a double door having an inner door and an outer door.

However, for the convenience of explanation, hereinafter, in a case where there are common descriptions that do not need to be distinguished among a plurality of components included in the doors 31, 32, 33, and 34, the symbols a and b may not be included in the drawing reference numerals. As an example, the description for the inner door 100 may be a description common to both the inner door 100a of the upper left door 31 and the inner door 100b of the upper right door 32. As an example, the description for the outer door 200 may be a description common to both the outer door 200a of the upper left door 31 and the outer door 200b of the upper right door 32.

Accordingly, the components and features of each of the inner door 100 and the outer door 200, which will be described later, may be commonly applied to each of the inner and outer doors of the upper left door 31, the upper right door 32, the lower left door 33, and the lower right door 34.

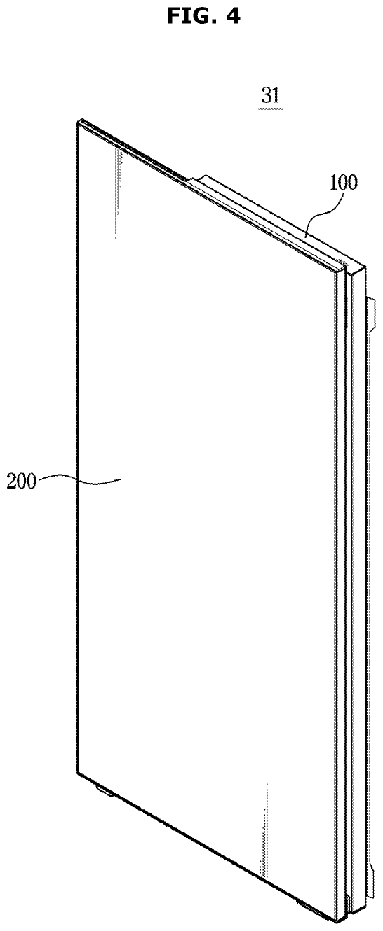

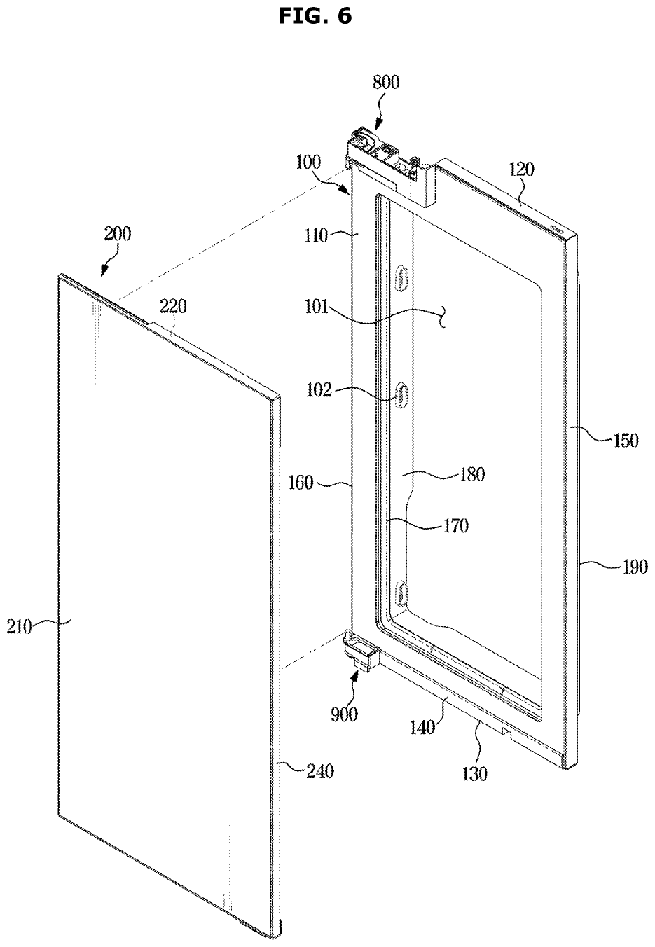

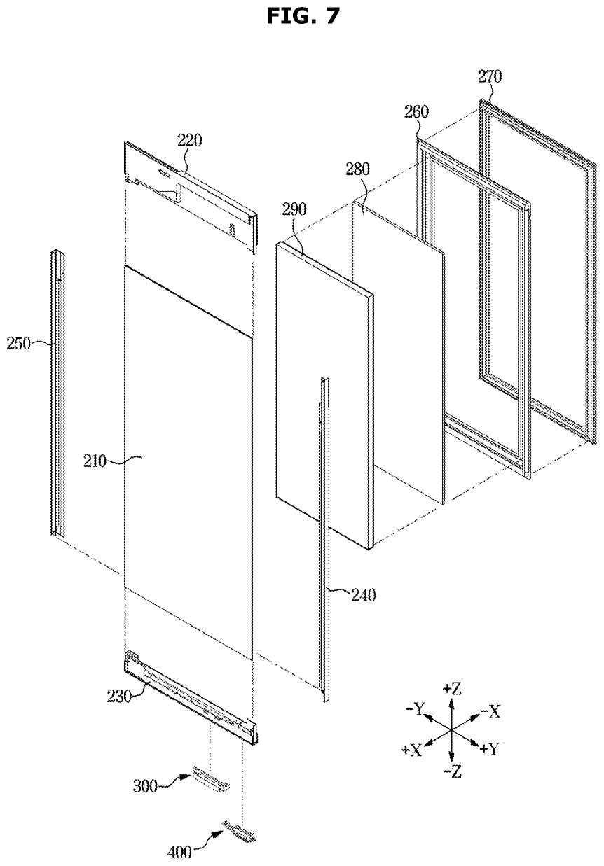

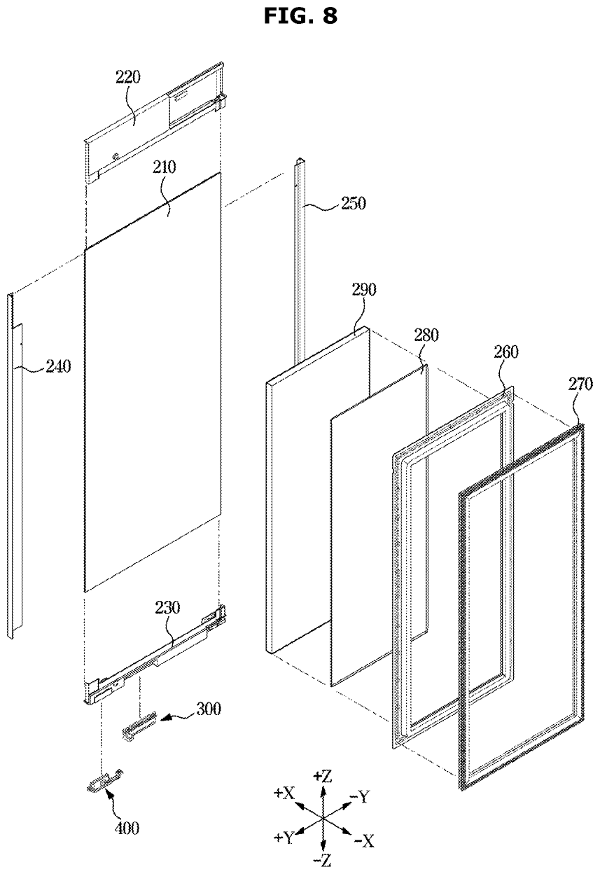

FIG. 4 is a perspective view illustrating a door according to an embodiment of the present disclosure. FIG. 5 is a perspective view illustrating a state in which the outer door is opened in the door according to an embodiment of the present disclosure. FIG. 6 is a perspective view illustrating a state in which the outer door and an inner door are separated according to an embodiment of the present disclosure. FIG. 7 is an exploded perspective view of the outer door according to an embodiment of the present disclosure. FIG. 8 is an exploded perspective view of the outer door according to an embodiment of the present disclosure.

Referring to FIGS. 4 to 8, the inner door 100 may include a first front plate 110. The first front plate 110 may be provided at a front portion of the inner door 100. The first front plate 110 may form a front surface of the inner door 100.

An opening may be formed on the first front plate 110. The opening formed on the first front plate 110 may be provided on an inner side of the first front plate 110. The opening formed on the first front plate 110 may be formed to penetrate a central portion of the first front plate 110 in a front-rear direction.

The inner door 100 may include door caps 120 and 130. The door caps 120 and 130 may be coupled to an upper end of the first front plate 110 or to a lower end of the first front plate 110. Specifically, the door caps 120 and 130 may include the first door cap 120 coupled to the upper end of the first front plate 110 and the second door cap 130 coupled to the lower end of the first front plate 110. That is, the first door cap 120 may be provided on an upper side of the first front plate 110, and the second door cap 130 may be provided on a lower side of the first front plate 110.

The first door cap 120 may be provided at an upper end of the inner door 100. The first door cap 120 may form an upper surface of the inner door 100.

The second door cap 130 may be provided at a lower end of the inner door 100. The second door cap 130 may form a portion of a lower surface of the inner door 100.

The inner door 100 may include a lower cover 140. The lower cover 140 may be provided at the lower end of the inner door 100. The lower cover 140 may form another portion of the lower surface of the inner door 100. The lower cover 140 may be coupled to a lower side of the second door cap 130.

The inner door 100 may include a first side chassis 150. The first side chassis 150 may be provided at one side end of the inner door 100. The first side chassis 150 may form one side surface of the inner door 100. Specifically, the first side chassis 150 may form a left surface of the inner door 100 at a left end of the inner door 100.

The first side chassis 150 may be coupled to one side of the first front plate 110. The first side chassis 150 may be provided on one side of the first front plate 110. Specifically, the first side chassis 150 may be provided on a left side of the first front plate 110.

The inner door 100 may include a second side chassis 160. The second side chassis 160 may be provided at the other side end of the inner door 100. The second side chassis 160 may form the other side surface of the inner door 100. Specifically, the second side chassis 160 may form a right surface of the inner door 100 at a right end of the inner door 100.

The second side chassis 160 may be coupled to the other side of the first front plate 110. The second side chassis 160 may be provided on the other side of the first front plate 110. Specifically, the second side chassis 160 may be provided on a right side of the first front plate 110.

The inner door 100 may include a trim 170. The trim 170 may be coupled to a rear surface of the first front plate 110. The trim 170 may be provided at the rear of the first front plate 110.

The trim 170 may extend along an edge of the opening formed on the first front plate 110. Through this configuration, an opening may be formed on the trim 170 that penetrates a central portion thereof in the front-rear direction. The opening formed on the trim 170 may be formed to penetrate the central portion of the trim 170 in the front-rear direction.

The inner door 100 may include a first door liner 180. The first door liner 180 may be provided on the rear of the first front plate 110 and the trim 170.

The first door liner 180 may form a basket support 102. Specifically, the basket support 102 may be formed by a portion protruding rearward from the first door liner 180.

An opening corresponding to the opening formed on the trim 170 may be formed on the first door liner 180. The opening formed on the first door liner 180 may be provided on an inner side of the first door liner 180. The opening formed on the first door liner 180 may be formed to penetrate a central portion of the first door liner 180 in the front-rear direction.

The opening formed on the first front plate 110, the opening formed on the trim 170, and the opening formed on the first door liner 180 may be communicated with each other. The opening formed on the first front plate 110, the opening formed on the trim 170, and the opening formed on the first door liner 180 may form a door opening 101.

The inner door 100 may include a first gasket 190. The first gasket 190 may be configured to seal between the main body 10 and the inner door 100 when the inner door 100 is closed. The first gasket 190 may be coupled to a rear surface of the first door liner 180.

The first gasket 190 may extend along an edge of the inner door 100. In other words, the first gasket 190 may extend along an edge of the first door liner 180.

The first front plate 110, the first door cap 120, the second door cap 130, the first side chassis 150, the second side chassis 160, the trim 170, and the first door liner 180 may form an accommodating space for accommodating a component for insulating the refrigerator 1. The component for insulating the refrigerator 1 may include an insulator such as foamed polyurethane or a vacuum insulation panel. However, there is no a special restriction on the component for insulating the refrigerator 1.

The outer door 200 may include a second front plate 210. The second front plate 210 may be provided at a front portion of the outer door 200. The second front plate 210 may form a front surface of the outer door 200.

The outer door 200 may include a third door cap 220. The third door cap 220 may be provided at an upper end of the outer door 200. The third door cap 220 may form an upper surface of the outer door 200.

The third door cap 220 may be coupled to an upper end of the second front plate 210. The third door cap 220 may be provided on an upper side of the second front plate 210.

The outer door 200 may include a fourth door cap 230. The fourth door cap 230 may be provided at a lower end of the outer door 200. The fourth door cap 230 may form a lower surface of the outer door 200.

The fourth door cap 230 may be coupled to a lower end of the second front plate 210. The fourth door cap 230 may be provided on a lower side of the second front plate 210.

The outer door 200 may include a third side chassis 240. The third side chassis 240 may be provided at one side end of the outer door 200. The third side chassis 240 may form one side surface of the outer door 200. Specifically, the third side chassis 240 may form a left surface of the outer door 200 at a left end of the outer door 200.

The third side chassis 240 may be coupled one side of the second front plate 210. The third side chassis 240 may be provided on one side of the second front plate 210. Specifically, the third side chassis 240 may be provided on a left side of the second front plate 210.

The outer door 200 may include a fourth side chassis 250. The fourth side chassis 250 may be provided at the other side end of the outer door 200. The fourth side chassis 250 may form the other side surface of the outer door 200. Specifically, the fourth side chassis 250 may form a right surface of the outer door 200 at a right side end of the outer door 200.

The fourth side chassis 250 may be coupled to the other side of the second front plate 210. The fourth side chassis 250 may be provided on the other side of the second front plate 210. Specifically, the fourth side chassis 250 may be provided on a right side of the second front plate 210.

The outer door 200 may include a second door liner 260. The second door liner 260 may be provided at the rear of the second front plate 210.

An opening may be formed on the second door liner 260. The opening formed on the second door liner 260 may be provided on an inner side of the second door liner 260. The opening formed on the second door liner 260 may be formed to penetrate a central portion of the second door liner 260 in the front-rear direction.

The outer door 200 may include a second gasket 270. The second gasket 270 may be configured to seal between the inner door 100 and the outer door 200 when the outer door 200 is closed. The second gasket 270 may be coupled to a rear surface of the second door liner 260.

The second gasket 270 may extend along an edge of the outer door 200. In other words, the second gasket 270 may extend along an edge of the second door liner 260.

The outer door 200 may include a rear plate 280. The rear plate 280 may be provided on a rear portion of the outer door 200. The rear plate 280 may form a rear surface of the outer door 200.

The rear plate 280 may be provided at the rear of the second front plate 210. The rear plate 280 may be coupled to the second door liner 260 at the front of the second door liner 260.

The outer door 200 may include an insulation panel 290. The insulation panel 290 may be configured to insulate the refrigerator 1. The insulation panel 290 may include a vacuum insulation panel.

The insulation panel 290 may be accommodated in an accommodating space in which the second front plate 210, the third door cap 220, the fourth door cap 230, the third side chassis 240, the fourth side chassis 250, the second door liner 260, and the rear plate 280 are formed. For example, the insulation panel 290 may be disposed in a central portion of the accommodating space.

The outer door 200 may additionally include a component for insulating the refrigerator 1 in addition to the insulation panel 290. For example, outer door 200 may further include a separate insulation panel distinct from insulation panel 290, or an insulator such as foamed urethane. In addition to the insulation panel 290, the component for insulating the refrigerator 1 may be accommodated in a space other than the space occupied by the insulation panel 290 in the above accommodating space.

The outer door 200 may include an opening/closing device 300. The opening/closing device 300 may be configured to open and close the outer door 200.

The opening/closing device 300 may be disposed at the lower end of the outer door 200. At least a portion of the opening/closing device 300 may be configured to be accessible from an outer side of the refrigerator 1.

The outer door 200 may include a touch sensor 400. The touch sensor 400 may be configured to detect touch of a user to open the inner door 100. For example, when the inner door 100 is closed, the user may open the inner door 100 by touching the touch sensor 400.

The touch sensor 400 may be disposed at the lower end of the outer door 200. At least a portion of the touch sensor 400 may be provided on a lower side of the outer door 200 to be accessible from the outer side of the refrigerator 1.

The refrigerator 1 may include an upper hinge device 800. The upper hinge device 800 may be coupled to an upper side of the inner door 100. The upper hinge device 800 may rotatably support the outer door 200.

The upper hinge device 800 may be provided at one end of the inner door 100. For example, the upper hinge device 800 may be provided at the right end of the inner door 100 when the inner door 100 is closed.

The upper hinge device 800 may be provided at one end of the outer door 200. For example, the upper hinge device 800 may be provided at a right end of the outer door 200 when the outer door 200 is closed.

The refrigerator 1 may include a lower hinge device 900. The lower hinge device 900 may be coupled to a lower side of the inner door 100. The lower hinge device 900 may rotatably support the outer door 200.

The lower hinge device 900 may be provided at one end of the inner door 100. For example, the lower hinge device 900 may be provided at the right end of the inner door 100 when the inner door 100 is closed.

The lower hinge device 900 may be provided at one end of the outer door 200. For example, the lower hinge device 900 may be provided at the right end of the outer door 200 when the outer door 200 is closed.

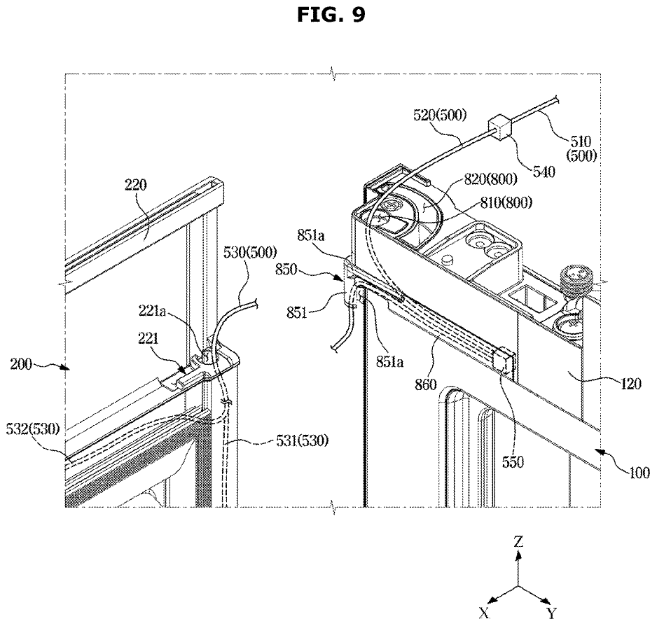

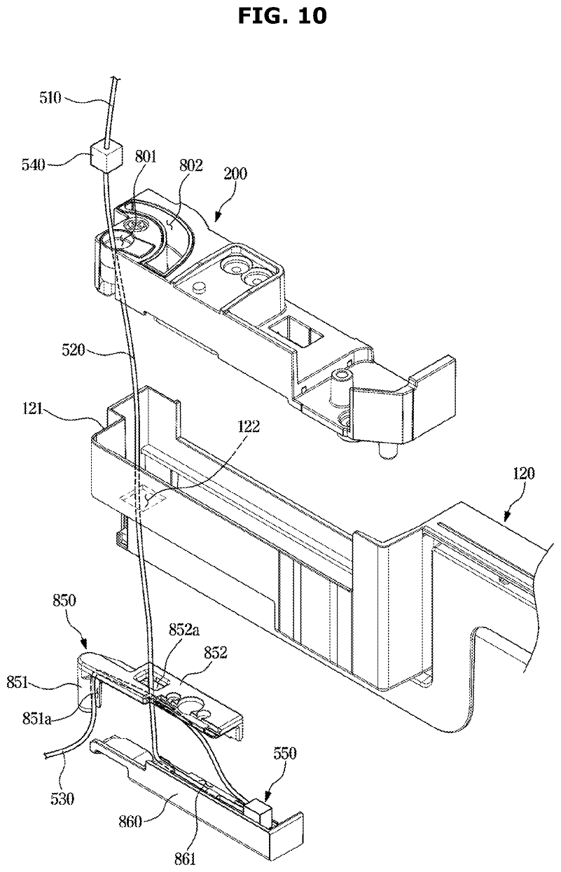

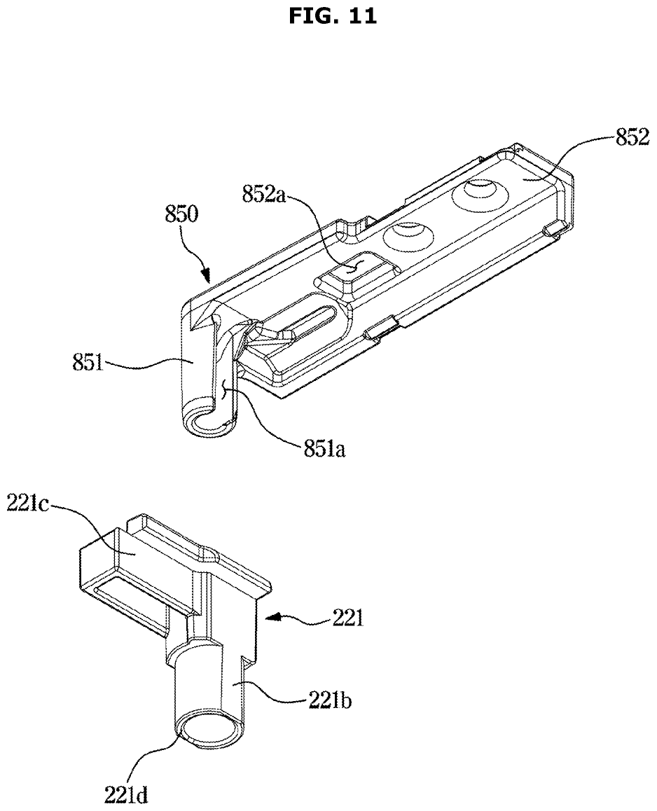

FIG. 9 is an enlarged view illustrating a state in which the inner door and the outer door are separated in a region corresponding to region A in FIG. 5 according to an embodiment of the present disclosure. FIG. 10 is a view illustrating a state in which some components of the inner door are separated according to an embodiment of the present disclosure. FIG. 11 is a view illustrating a state in which some components of the door are separated according to an embodiment of the present disclosure.

Hereinafter, for convenience of explanation, components substantially identical or similar to those described with reference to FIGS. 4 to 8 may be omitted or briefly described.

Referring to FIGS. 9 to 11, the door of the refrigerator 1 may include the inner door 100 and the outer door 200. The refrigerator 1 may be provided with a double door structure.

The inner door 100 may be configured to be rotatable relative to the main body 10. Accordingly, the upper hinge device 800 and the lower hinge device 900 rotatably coupled to the main body 10 may be provided on the inner door 100.

The inner door 100 and the outer door 200 may be rotatably coupled. To this end, a first hinge 850 may be provided on an upper portion of the inner door 100. The first hinge 850 may be provided such that one end is coupled to the inner door 100 side and the other end is rotatably inserted into the outer door 200 side.

The first hinge 850 may include a first hinge shaft 851 and a first hinge plate 852. The first hinge plate 852 may be fixed by screwing to a lower surface of the first door cap 120 of the inner door 100. The first hinge shaft 851 may be provided to protrude to the outer door 200 side.

The first hinge shaft 851 may be provided to be inserted into the outer door 200. A hinge member 221 including a hinge insertion hole 221a may be provided at an upper end of the third door cap 220 of the outer door 200. The first hinge shaft 851 may be accommodated in the hinge insertion hole 221a of the hinge member 221. Accordingly, the first hinge shaft 851 fixed to the inner door 100 may be inserted into the hinge insertion hole 221a provided on the outer door 200, so that the outer door 200 may be rotatably coupled to the inner door 100.

That is, the first hinge 850 may serve as an upper hinge connecting the inner door 100 and the outer door 200. Correspondingly, a second hinge may be provided between the lower end of the inner door 100 and the lower end of the outer door 200. The description of the first hinge 850 described above may also be commonly applied to the second hinge.

In the refrigerator 1 according to an embodiment of the present disclosure, a path may be provided for withdrawing an electric wire 500 from the main body 10 into the inside of the outer door 200. The electric wire 500 may include a plurality of the electric wires 500 electrically connected to each other. For example, the electric wire 500 may include a main body electric wire 510, an inner door electric wire 520, and an outer door electric wire 530. For example, the main body electric wire 510 may be connected to the inner door electric wire 520. For example, the inner door electric wire 520 may be connected to the outer door electric wire 530.

For example, the main body electric wire 510 passed through the main body 10 side of the refrigerator 1 may be connected to the inner door electric wire 520 passed through the upper hinge device 800 of the inner door 100 near the upper hinge device 800. In this case, the main body electric wire 510 and the inner door electric wire 520 may be connected through a main body-side connector 540. The drawing illustrates that the main body-side connector 540 is a single connector, but the present disclosure is not limited thereto. For example, the main body-side connector 540 may be provided in plurality. The main body-side connector 540 may include a first main body-side connector and a second main body-side connector. The first main body-side connector may be provided at one end of the main body electric wire 510, and the second main body-side connector may be provided at one end of the inner door electric wire 520. As the first main body-side connector and the second main body-side connector are connected, the main body electric wire 510 and the inner door electric wire 520 may be connected.

The main body-side connector 540 may be provided between the main body electric wire 510 and the inner door electric wire 520. The main body-side connector 540 may be positioned on the upper surface of the main body 10.

The inner door electric wire 520 may pass through the upper hinge device 800 provided on the inner door 100 and be connected to the outer door electric wire 530 withdrawn into the inside of the outer door 200 near the outer door 200. In this case, the inner door electric wire 520 and the outer door electric wire 530 may be connected through a door-side connector 550. The door-side connector 550 may be provided between the inner door electric wire 520 and the outer door electric wire 530. The door-side connector 550 may be positioned on a lower side of the upper hinge device 800.

The inner door electric wire 520 may pass through the first door cap 120 of the inner door 100 in an up-down direction through the upper hinge device 800. Accordingly, the inner door electric wire 520 may be withdrawn into a lower portion of the first hinge 850 disposed on the lower side of the upper hinge device 800.

Specifically, the upper hinge device 800 may be provided on the upper portion of the inner door 100. The upper hinge device 800 may be provided on an upper side of the first door cap 120. The upper hinge device 800 may be coupled to the first door cap 120.

The first door cap 120 may have a hinge mounting part 121 formed on one side close to a rotation axis of the inner door 100. The hinge mounting part 121 may be provided in a basket shape protruding forward from the first door cap 120. The hinge mounting part 121 may accommodate the upper hinge device 800. A space may be provided inside the hinge mounting part 121 to accommodate the upper hinge device 800. The upper hinge device 800 may be mounted inside the hinge mounting part 121.

An opening 122 may be formed on a lower surface of the hinge mounting part 121. Accordingly, the inner door electric wire 520 passed through the upper hinge device 800 may pass through the hinge mounting part 121 in the up-down direction.

At least a portion of the hinge mounting part 121 may be provided to protrude forward from the first door cap 120. Accordingly, the first hinge 850 may be coupled to a lower surface of the portion protruding forward from the hinge mounting part 121. The first hinge plate 852 may be fixed to a lower side of the lower surface of the hinge mounting part 121.

A passing hole 852a may be formed on the first hinge plate 852. Accordingly, the inner door electric wire 520 passed through the hinge mounting part 121 may pass through the first hinge plate 852 in the up-down direction.

The passing hole 852a of the first hinge plate 852 may be provided in a closed shape. Accordingly, the inner door electric wire 520 passed through the first hinge plate 852 may be fixed at an inner side of the passing hole 852a of the first hinge plate 852.

The positions of the opening 122 formed on the lower surface of the hinge mounting part 121 and the passing hole 852a formed on the first hinge plate 852 may correspond to each other. In other words, the opening 122 of the hinge mounting part 121 and the passing hole 852a of the first hinge plate 852 may be communicated. Accordingly, the inner door electric wire 520 passed through the upper hinge device 800 may pass through the hinge mounting part 121 and the first hinge plate 852 and be withdrawn into a lower region of the first hinge 850. That is, a path for the electric wire 500 may be formed in the hinge structure of the inner door 100.

A first hinge cover 860 may be provided on a lower side of the first hinge 850. The first hinge cover 860 may be coupled to a lower portion of the hinge mounting part 121. The first hinge cover 860 may form an electric wire accommodating space 861 on a lower side of the first hinge plate 852. That is, the inner door electric wire 520 passed through the passing hole 852a of the first hinge plate 852 may be withdrawn into the electric wire accommodating space 861.

The inner door electric wire 520 withdrawn into the electric wire accommodating space 861 may be connected to the outer door electric wire 530 withdrawn into the inside of the outer door 200. In the electric wire accommodating space 861, the inner door electric wire 520 and the outer door electric wire 530 may be electrically connected.

In this case, the inner door electric wire 520 and the outer door electric wire 530 may be connected through the door-side connector 550. The door-side connector 550 may be provided between the inner door electric wire 520 and the outer door electric wire 530. The drawings illustrate that the door-side connector 550 is a single connector, but the present disclosure is not limited thereto. For example, the door-side connector 550 may be provided in plurality. The door-side connector 550 may include a first door-side connector and a second door-side connector. The first door-side connector may be provided at one end of the inner door electric wire 520, and the second door-side connector may be provided at one end of the outer door electric wire 530. As the first door-side connector and the second door-side connector are coupled, the inner door electric wire 520 and the outer door electric wire 530 may be connected.

The door-side connector 550 may be provided on an upper side of the first hinge cover 860. The first hinge cover 860 may cover the door-side connector 550 and the inner door electric wire 520 and the outer door electric wire 530 connected through the door-side connector 550. The first hinge connector may be provided to cover the front and bottom.

In the electric wire accommodating space 861, the outer door electric wire 530 connected to the inner door electric wire 520 may be withdrawn into the inside of the outer door 200. The outer door electric wire 530 may be withdrawn into the inside of the outer door 200 through the first hinge shaft 851.

The hinge insertion hole 221a into which the first hinge shaft 851 is inserted may be provided in the outer door 200. The hinge insertion hole 221a may be provided such that the inside and outside of the outer door 200 are communicated.

Specifically, the first hinge shaft 851 may be rotatably inserted into the hinge insertion hole 221a. The first hinge shaft 851 may be provided to be in contact with an inner circumferential surface of the hinge insertion hole 221a.

A shaft groove 851a extending in a shaft direction may be formed on an outer circumferential surface of the first hinge shaft 851. The shaft groove 851a may be formed by being recessed in the outer circumferential surface of the first hinge shaft 851. The shaft groove 851a may extend to an end of the first hinge shaft 851.

The hinge insertion hole 221a of the outer door 200 may be formed in the third door cap 220 or the outer door 200. The hinge member 221 including the hinge insertion hole 221a may be provided in the third door cap 220 or the outer door 200. Alternatively, the hinge insertion hole 221a may be formed directly in the third door cap 220.

According to an embodiment, the hinge member 221 including the hinge insertion hole 221a may be provided separately from the third door cap 220. The hinge member 221 may be coupled to one side of the third door cap 220 close to a rotation axis R of the outer door 200. The hinge member 221 may be provided to couple the outer door 200 and the first hinge 850. The hinge member 221 may guide the outer door electric wire 530 provided on the outside of the outer door 200 to be withdrawn into the inside of the outer door 200.

The hinge member 221 may include a coupling part 221c coupled to the third door cap 220 or the outer door 200, and a communicating hole part 221b in which a hollow space is formed. The communicating hole part 221b may extend downward from the coupling part 221c. The hinge insertion hole 221a may be formed on an upper side of the communicating hole part 221b. An electric wire withdrawing portion 221d may be provided on a lower side of the communicating hole part 221b. The hinge insertion hole 221a and the electric wire withdrawing portion 221d may be formed as a single structure connected to each other. The outer door electric wire 530 may be withdrawn into the inside of the outer door 200 by passing through the electric wire withdrawing portion 221d.

The shaft groove 851a of the first hinge shaft 851 may be provided such that the inside of the outer door 200 and the electric wire accommodating space 861 are communicated with each other when the first hinge shaft 851 is inserted into the hinge insertion hole 221a of the outer door 200. Specifically, the first hinge shaft 851 may be inserted into the hinge insertion hole 221a of the hinge member 221. The end of the first hinge shaft 851 may be positioned inside the communicating hole part 221b of the hinge member 221. The end of the first hinge shaft 851 may be positioned in the hollow space provided in the communicating hole part 221b of the hinge member 221.

Accordingly, the shaft groove 851a extending to the end of the hinge shaft 851 may be provided in a shape opened toward the inside of the communicating hole part 221b. Accordingly, the outer door electric wire 530 provided in the electric wire accommodating space 861 may be withdrawn into the inside of the outer door 200 through the first hinge shaft 851.

Accordingly, in the refrigerator 1 according to an embodiment of the present disclosure, a path may be provided for the electric wire 500 in the upper hinge region to pass from the main body 10 to the inner door 100 and be withdrawn into the outer door 200, and therefore not only may the electric wire 500 be protected without any additional components, but power may also be supplied to the inside of the outer door 200. In addition, in the refrigerator 1 according to an embodiment of the present disclosure, the electric wire 500 may extend to the inside of the outer door 200 without being exposed to the outside, thereby improving the appearance quality of a product and preventing the electric wire from being disconnected or fatigued due to opening and closing the door.

The outer door electric wire 530 may be provided to supply power or transmit signals from a controller of the main body 10 to various electric components installed in the outer door 200. The outer door electric wire 530 withdrawn into the inside of the outer door 200 may include a first electric wire 531 and a second electric wire 532.

For example, the first electric wire 531 may include a signal line and/or a power line electrically connected to an electronic component, such as the touch sensor 400 provided on the lower surface of the outer door 200.

For example, the second electric wire 532 may include a grounding electric wire that serves as a ground.

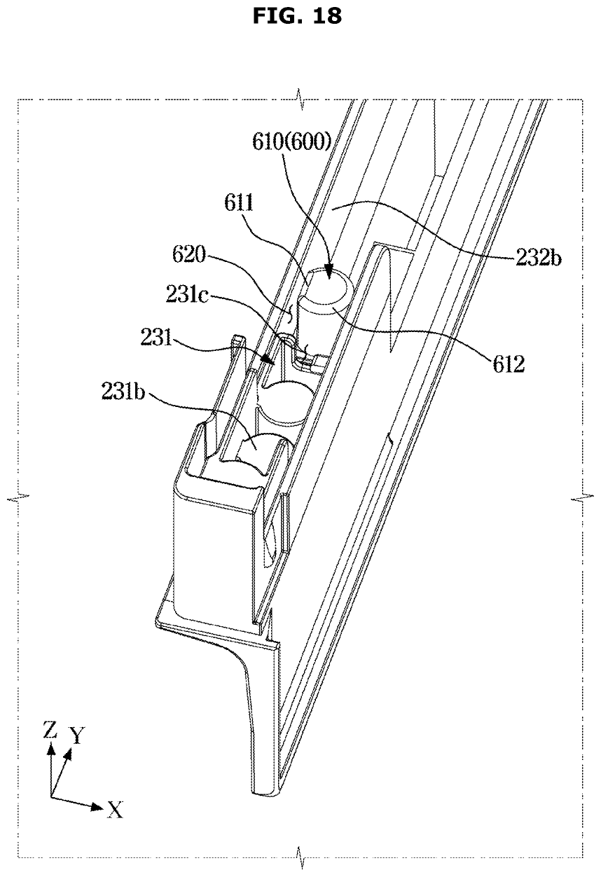

Specifically, the electric wire 500, which has entered the inside of the outer door 200 through the electric wire withdrawing portion 221d, may extend downward along a right edge side in an inside space of the outer door 200. The outer door electric wire 530 may be extended by be branched into the first electric wire 531 and the second electric wire 532 after passing through the electric wire withdrawing portion 221d. Accordingly, a degree of interference between the first electric wire 531 and the second electric wire 532 may be reduced. The first electric wire 531 lowered along a right inner surface of the outer door 200 may be guided toward the left side from a lower portion of the outer door 200. To this end, an electric wire fixing part 600 (see FIG. 18), which will be described later, may be provided in the inside of the outer door 200. A detailed description of the electric wire fixing part 600 will be provided later.

However, the present disclosure is not limited thereto. The first electric wire 531 and the second electric wire 532 may not be branched but may be arranged together and lowered.

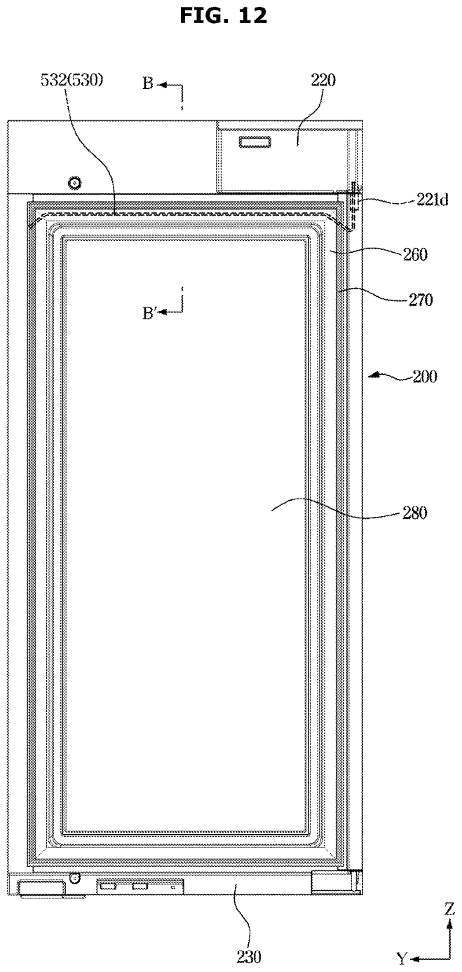

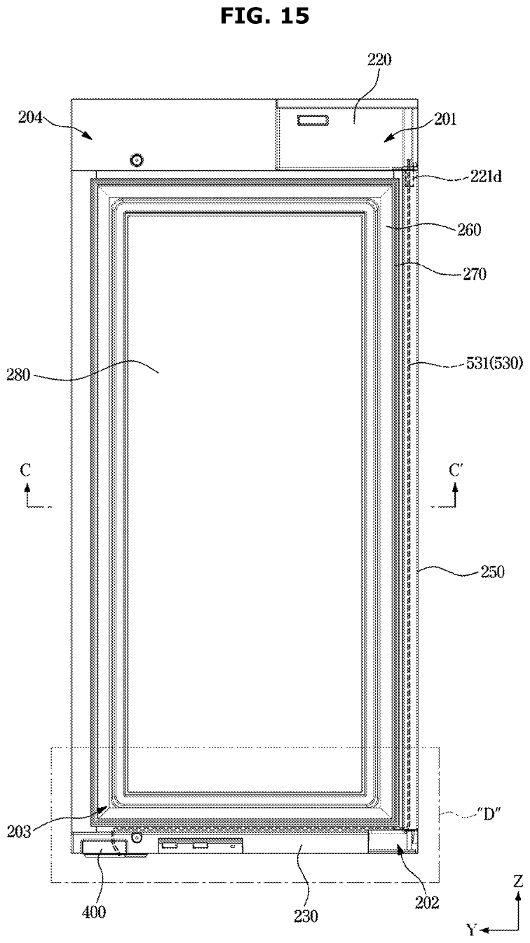

Hereinafter, arrangement of the second electric wire 532 and components guiding the second electric wire 532 will be described with reference to FIGS. 12 to 14, and arrangement of the first electric wire 531 and components guiding the first electric wire 531 will be described with reference to FIGS. 15 to 24.

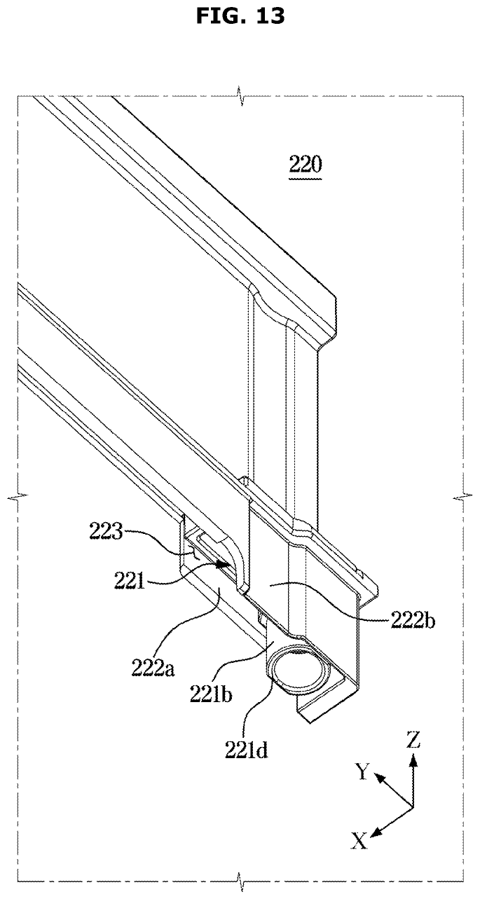

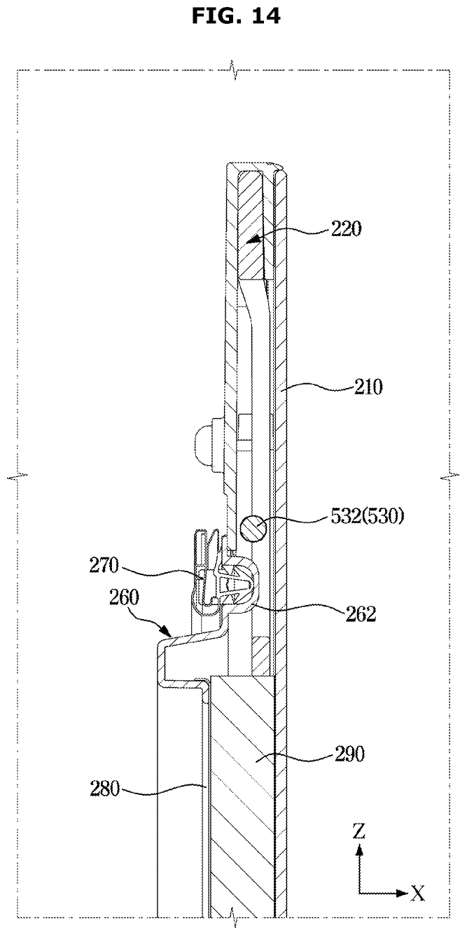

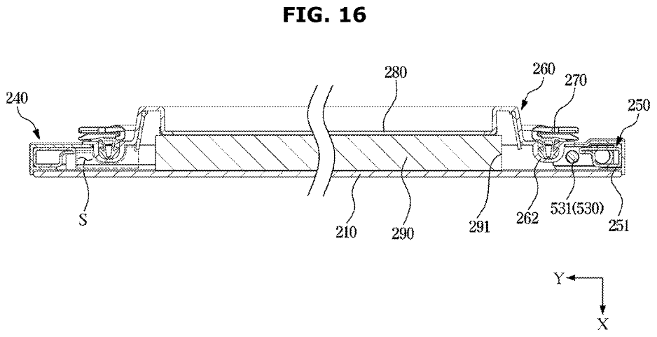

FIG. 12 is a rear view of the outer door for explaining arrangement of an electric wire inside the outer door according to an embodiment of the present disclosure. FIG. 13 is a perspective view illustrating some components of the outer door according to an embodiment of the present disclosure. FIG. 14 is a cross-sectional view of the outer door cut along line B-B′ in FIG. 12 according to an embodiment of the present disclosure. FIG. 15 is a rear view of the outer door for explaining arrangement of an electric wire inside the outer door according to an embodiment of the present disclosure. FIG. 16 is a cross-sectional view of the outer door cut along line C-C′ in FIG. 15 according to an embodiment of the present disclosure.

Referring to FIGS. 12 to 16, the second electric wire 532, which is part of the outer door electric wire 530, may be introduced into the inside of the outer door 200 through the hinge member 221, and then branched and extend in the lateral direction without extending further downward along the communicating hole part 221b of the hinge member 221. In other words, the second electric wire 532 may extend in the lateral direction along an upper region of the inside space of the outer door 200. The second electric wire 532 may be connected to a metal member or hinge structure of the outer door 200 and grounded.

The third door cap 220 may be provided to facilitate the extension of the second electric wire 532 in the lateral direction. Inside the third door cap 220, a wall 222 may be formed to surround the communicating hole part 221b of the hinge member 221. The wall 222 may be a pair of extension members lowered from front and rear surfaces of the inside of the third door cap 220. The wall 222 may include a front-side wall part 222a and a rear-side wall part 222b. The front-side wall part 222a and the rear-side wall part 222b may be spaced apart from each other in the front-rear direction. The front-side wall part 222a and the rear-side wall part 222b may be arranged in a shape of surrounding the communicating hole part 221b of the hinge member 221 on both surfaces in the front-rear direction. The communicating hole part 221b may be supported to be fixed in a correct position inside the upper door cap 220.

In this embodiment, the wall parts 222a and 222b of the third door cap 220 may be configured as a structure opened therebetween. In other words, a gap may be formed between the front-side wall part 222a and the rear-side wall part 222b without an intermediate wall. As such, a second electric wire guide portion 223 may be formed in an open space opened between the wall parts 222a and 222b. The second electric wire guide portion 223 may be provided to guide the second electric wire 532. The second electric wire guide portion 223 may function as a passage for the second electric wire 532.

That is, the second electric wire 532 withdrawn into an upper side of the outer door 200 through the hinge member 221 may pass through the open gap between the wall parts 222a and 222b and be arranged in the lateral direction along a lower surface of the third door cap 220. As the second electric wire guide portion 223 is formed as a part of the structure of the third door cap 220 without a special separate part, the refrigerator 1 according to an embodiment of the present disclosure may perform an electric wire mounting function without increasing the number of parts.

The drawing illustrates that the second electric wire guide portion 223 of the third door cap 220 is provided by an open gap between wall parts 222a and 222b, but the present disclosure is not limited thereto. For example, the third door cap 220 may include the second electric wire guide portion 223 even in a case where a gap between the wall parts 222a and 222b is provided in a closed form. An intermediate wall part may be provided in the third door cap 220 to connect the front-side wall part 222a and the rear-side wall part 222b. In this case, a first electric wire guide groove 231c through which the second electric wire 532 may pass may be formed on the intermediate wall part.

That is, in a case where a structure corresponding to the open gap is provided, the second electric wire guide portion 223 for guiding the second electric wire 532 laterally to the third door cap 220 may be provided even though the gap between the wall parts 222a and 222b of the third door cap 220 is not opened.

The second electric wire 532 may be provided on an outer side of an upper edge of the insulation panel 290. Specifically, the second electric wire 532 may be arranged on an outer upper portion of a second gasket mounting portion 262 of the second door liner 260. The second gasket mounting portion 262 may be provided in a shape of protruding toward the second front plate 210. Accordingly, the second electric wire 532 may be provided to be stably spaced apart from the insulation panel 290.

The second gasket mounting portion 262 may be provided between the second electric wire 532 and the insulation panel 290. The second gasket mounting portion 262 may be provided in a shape of protruding forward in an inner space of the outer door 200. Accordingly, the second gasket mounting portion 262 may be provided such that the second electric wire 532 and the insulation panel 290 are separated.

Accordingly, the second electric wire 532 may be provided to be stably spaced apart from the insulation panel 290 even when a foaming agent is injected during a manufacturing process or when the outer door 200 is opened and closed during use of the product.

However, the present disclosure is not limited thereto. The second electric wire 532 may be arranged in various locations of not being in contact with the insulation panel. For example, the second electric wire 532 may be arranged inside the second gasket mounting portion 262 to be spaced apart from the insulation panel 290.

The first electric wire 531, which is part of the outer door electric wire 530, may be introduced into the inside of the outer door 200 through the hinge member 221 and then extend downward along a direction of being withdrawn from the communicating hole part 221b of the hinge member 221. In other words, the first electric wire 531 may extend in the shaft direction along a lateral region of the inside space of the outer door 200. The first electric wire 531 may be electrically connected to an electronic component such as the touch sensor 400 provided on the outer door 200 to supply power or transmit and receive signals.

The electric wire 500 arranged inside the outer door 200 may be provided so as not to interfere with the insulation panel 290 inside the outer door 200. Specifically, the outer door 200 may have an accommodating space formed therein.

The accommodating space may be formed by the second front plate 210, the third door cap 220, the fourth door cap 230, the third side chassis 240, the fourth side chassis 250, the second door liner 260, and the rear plate 280.

The insulation panel 290 may be accommodated in the accommodating space. The accommodating space may include a space other than the space occupied by the insulation panel 290.

The insulation panel 290 may be disposed in the central portion of the accommodating space. In this case, front and rear surfaces of the insulation panel 290 may be provided to be in contact with the second front plate 210 and the rear plate 280, respectively. Accordingly, the space other than the space occupied by the insulation panel 290 in the accommodating space may be provided the outer side of the edge of the insulation panel 290.

That is, the accommodating space may include a perimeter region S provided the outer side of the edge of the insulation panel 290. The perimeter region S may be a region formed between an outer side surface of the insulation panel 290 and an inner side surface of the outer door 200 formed by the third door cap 220, the fourth door cap 230, the third side chassis 240, and the fourth side chassis 250.

Accordingly, the perimeter region S may generally be provided with a shape corresponding to the shape of the outer door 200. For example, the perimeter region S may be formed in a square or similar shape. For example, the perimeter region S may be formed in a closed shape. Accordingly, in the perimeter region S, a plurality of corners may be formed at positions corresponding to respective vertices of the outer door 200.

The electric wire 500 withdrawn into the inside of the outer door 200 may be provided to extend along the perimeter region S so as not to interfere with the insulation panel 290 in the accommodating space inside the outer door 200. That is, the outer door electric wire 530 may be arranged in the perimeter region S. Accordingly, the outer door electric wire 530 may be arranged by bypassing the insulation panel 290 without overlapping with the insulation panel 290 in the front-rear direction.

Specifically, the corner of the perimeter region S may be formed at a position corresponding to a corner of the outer door 200. The corners of the outer door 200 may be provided to substantially correspond to four vertices of the outer door 200. The corner of the outer door 200 may refer to the vicinity of a point where the third door cap 220, the fourth door cap 230, the third side chassis 240, and the fourth side chassis 250 are connected to each other. Hereinafter, for convenience of explanation, when it is necessary to distinguish between the positions of the respective vertices (corners) of the outer door 200 or when it is necessary to distinguish between the positions of respective vertices (corners) of the perimeter region S, a first corner 201, a second corner 202, a third corner 203, and a fourth corner 204 may be defined to indicate the positions of the respective corners.

At the corner of the perimeter region S, an extension path of the outer door electric wire 530 provided along the perimeter region S may be changed. That is, the outer door electric wire 530 may be bent at the corner of the perimeter region S. To this end, a structure may be provided to fix the outer door electric wire 530 to the corner of the perimeter region S so that the outer door electric wire 530 is bent. A detailed description of the above structure will be described later in another drawing.

The outer door 200 may be provided with a sensor unit configured to detect a motion of the user and automatically open the door. In an embodiment of the refrigerator 1, the sensor unit may be installed at the lower portion of the outer door 200. For example, the sensor unit configured to recognize external information may be mounted on the lower end of the outer door 200. The sensor unit may be implemented as an infrared sensor or the touch sensor 400, etc., to detect a contact or signal of the user and initiate door opening. The sensor unit may be electrically connected to the controller. To this end, the electric wire 500, which transmits power and/or signals from the main body 10 of the refrigerator 1, may be provided to pass through the inside of the door.

In a case where the first electric wire 531 extends from the electric wire withdrawing portion 221d of the outer door 200 to the touch sensor 400, a line connecting the touch sensor 400 and the electric wire withdrawing portion 221d may pass the insulation panel 290 provided in the central portion.

However, the first electric wire 531 may be provided so as not to pass the central portion. The first electric wire 531 may be provided to bypass the insulation panel 290 provided in the central portion. To this end, the first electric wire 531 may be arranged along the perimeter region S.

More specifically, the first corner 201, the second corner 202, the third corner 203, and the fourth corner 204 may be provided in regions corresponding to the respective vertices along a perimeter direction of the door. For example, the electric wire withdrawing portion 221d and the touch sensor 400 may each be provided at one of the corners 201 to 204. In this case, the electric wire withdrawing portion 221d and the touch sensor 400 may be provided so as not to be adjacent to each other. For example, the electric wire withdrawing portion 221d may be provided at the first corner 201, and the touch sensor 400 may be provided at the third corner 203.

According to an embodiment of the present disclosure, the first electric wire 531 may extend along a first section provided in the perimeter region S between the first corner 201 and the second corner 202, and a second section provided in the perimeter region S between the second corner 202 and the third corner 203.

In other words, the first electric wire 531 withdrawn from the electric wire withdrawing portion 221d and then withdrawn into the inside of the outer door 200 may be arranged to extend downward along the perimeter of the outer door 200 from the right edge of the outer door 200 and to extend to the left by being bent at the second corner 202.

The first electric wire 531 may be provided between the inner side surface of the outer door 200 and the outer side surface of the insulation panel 290 in the first section. The first electric wire 531 may be arranged between an inner side surface 251 of the fourth side chassis 250 and the outer side surface of the insulation panel 290 in the first section. The first electric wire 531 may extend downward in a substantially vertical direction in the first section. Accordingly, the first electric wire 531 may be prevented from interfering with the insulation panel 290 provided in the central portion. The first electric wire 531 may be spaced apart from the insulation panel 290.

As an example, the first electric wire 531 may be provided further outward than the second gasket mounting portion 262 provided on an outer edge of the second door liner 260 in the first section. The first electric wire 531 may be provided between the second gasket mounting portion 262 and the inner side surface 251 of the fourth side chassis 250 in the first section.

The second gasket mounting portion 262 may be provided between the insulation panel 290 and the first electric wire 531. The second gasket mounting portion 262 may be provided to separate the first electric wire 531 and the insulation panel 290 by having a shape of protruding toward the second front plate 210 provided at the front.

The second gasket mounting portion 262 may protrude to sufficiently separate a center side and an outer side of the second gasket mounting portion 262 in the inner space of the outer door 200 as a thickness of the outer door 200 becomes thinner. Accordingly, the first electric wire 531 may be more stably spaced apart from the insulation panel 290.

However, the present disclosure is not limited thereto. The first electric wire 531 may be arranged in various locations of not being in contact with the insulation panel 290. For example, the first electric wire 531 may be positioned on the inner side of the second gasket 270 to be spaced apart from the insulation panel 290.

The first electric wire 531 extended to the lower side of the outer door 200 may be bent at the second corner 202 and extend toward the third corner 203. The first electric wire 531 extended along the first section may sequentially extend along the second section and be connected to the touch sensor 400. The first electric wire 531 passed through the second section may be arranged along the fourth door cap 230.

Accordingly, the first electric wire 531 may be provided to bypass the insulation panel 290 along the perimeter of the outer door 200 by not being provided to cross the insulation panel 290 in a central portion of the outer door 200, but being instead arranged along the perimeter region S. Accordingly, damage to the insulation panel 290 or deterioration of the insulation performance of the outer door 200 may be prevented.

To this end, the electric wire fixing part 600 (see FIG. 18), which will be described later, may be provided in the fourth door cap 230 so that the first electric wire 531 is positioned and maintained in a bent state at the second corner 202.

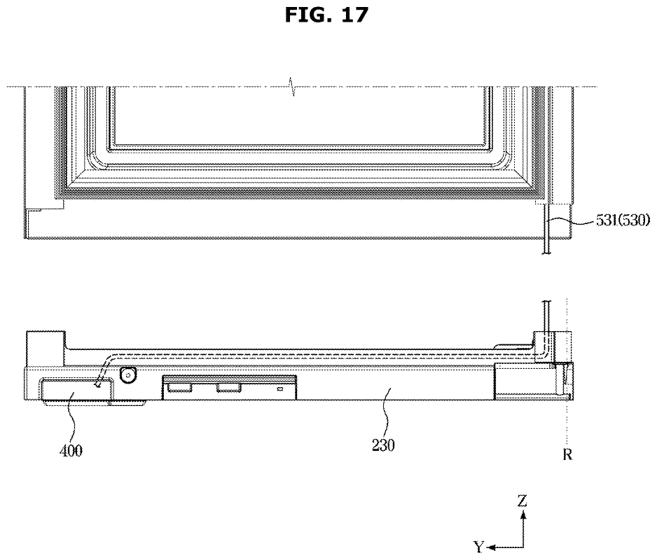

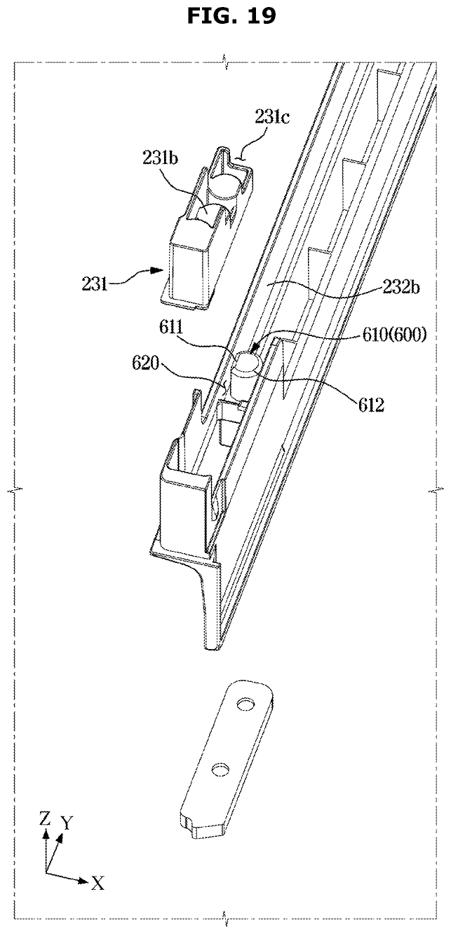

FIG. 17 is an enlarged view illustrating a state in which some components of the outer door are separated in a region corresponding to region D in FIG. 15 according to an embodiment of the present disclosure. FIG. 18 is a perspective view illustrating some components of the outer door according to an embodiment of the present disclosure. FIG. 19 is an exploded view illustrating some components of the outer door according to an embodiment of the present disclosure.

Hereinafter, for convenience of explanation, components substantially identical or similar to those described with reference to FIGS. 12 to 16 may be omitted or briefly described.

Referring to FIGS. 17 to 19, the electric wire 500 introduced along a rotation axis-side edge of the outer door 200 may be guided to the lower portion of the outer door 200 and then fixed at the second corner near the second hinge. To this end, the electric wire fixing part 600 may be provided in the fourth door cap 230 of the outer door 200.

The electric wire fixing part 600 may be configured to guide the electric wire 500 so that the electric wire may be arranged by being bent stably along the perimeter region S of the outer door 200 and to fix the electric wire in that position. More specifically, a lower guide rib 610 may be integrally formed inside the fourth door cap 230 adjacent to the second hinge. The lower guide rib 610 may be provided in a shape of protruding from a main body of the fourth door cap 230 toward the inside of the outer door 200, and may be disposed to be spaced apart from a wall 232 of the fourth door cap 230 in parallel, thereby forming a first electric wire guide gap 620 in which the first electric wire 531 is inserted therebetween.

The lower guide rib 610 may be provided in a protruding shape. The lower guide rib 610 may include a flat portion 611 and a curved portion 612 to stably support and fix the first electric wire 531. The flat portion 611 has a flat shape as a surface that the first electric wire 531 comes into contact with, and may form a guide gap having a constant width by maintaining a uniform spacing with the surface of an adjacent rear-side wall portion 232b. The curved portion 612 may be formed along the opposite outer side of the lower guide rib 610, and may increase forming stability through a gentle curve and prevent damage to the covering of the electric wire 500.

The lower guide rib 610 may guide the first electric wire 531 in a form of extending in both directions based on the perimeter direction of the outer door 200 at the corner of the outer door 200 provided near the lower hinge. That is, one side and the other side of the first electric wire 531 may extend to the first section extending in a main body 10 direction of the outer door 200, and a second section extending in a touch sensor 400 direction, based on the lower guide rib 610 provided at the second corner 202, respectively. Accordingly, the first electric wire 531 may be arranged by being bent in an L shape at the lower corner, and may be wired stably without sagging by being fixed at the bent portion.

Additionally, the lower guide rib 610 may also serve as a fastening function in addition to the electric wire fixing function. Specifically, a fastening hole open toward a lower surface of the fourth door cap 230 may be formed inside the lower guide rib 610. This fastening hole may be used as a function of fixing a stopper member limiting an opening angle of the outer door 200 by allowing a screw to be inserted from a lower outer side of the outer door 200, and allow the lower guide rib 610 to function as a structure for screw fastening without a separate boss.

Therefore, the electric wire fixing part 600 may simultaneously perform the functions of fixing the first electric wire 531 and fastening the stopper member, thereby reducing the number of parts and improving the space utilization and assembly convenience inside the outer door 200.

Additionally, a coupling member 231 may be provided on the fourth door cap 230. The coupling member 231 may be used as a function of fixing the stopper member by being positioned adjacent to the lower guide rib 610. A screw assembling part 231b may be provided on the coupling member 231 as an additional screw fastening boss.

The coupling member 231 may include the screw assembling part 231b and the first electric wire guide groove 231c. The first electric wire guide groove 231c may be provided in a body of the coupling member 231. The first electric wire guide groove 231c may be provided to guide the first electric wire 531 bent at the second corner 202 to the first electric wire guide gap 620.

The first electric wire guide groove 231c may be provided at a position corresponding to a middle of the lower guide rib 610. Accordingly, the first electric wire 531, which has passed through the first electric wire guide groove 231c and the first electric wire guide gap 620 sequentially, may be additionally bent in the first electric wire guide groove 231c and the first electric wire guide gap 620. Accordingly, the first electric wire 531 may be more stably fixed in the first electric wire guide gap 620.

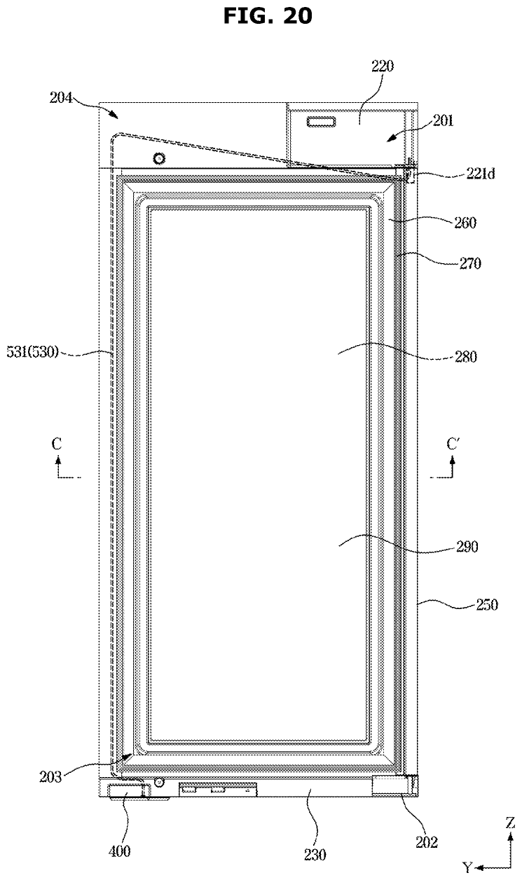

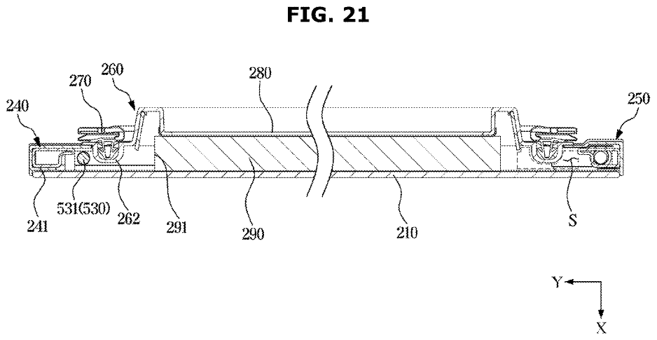

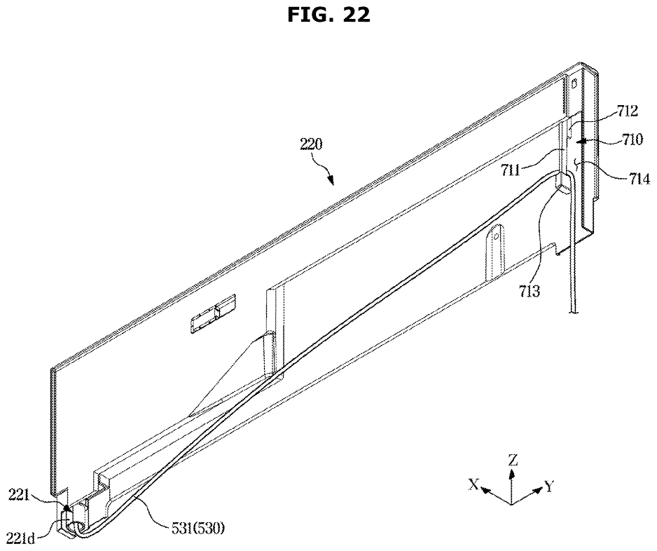

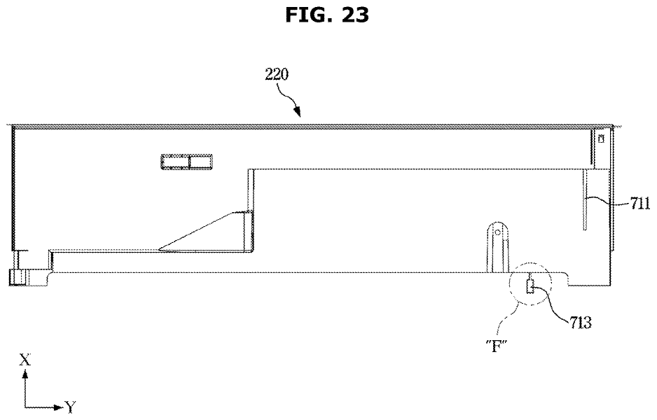

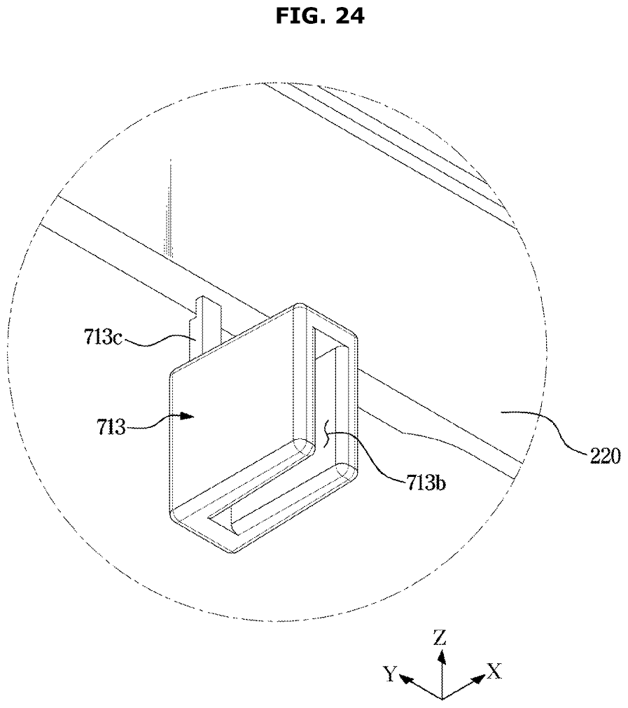

FIG. 20 is a rear view of the outer door for explaining arrangement of an electric wire inside the outer door according to an embodiment of the present disclosure. FIG. 21 is a cross-sectional view of the outer door cut along line E-E′ in FIG. 20 according to an embodiment of the present disclosure. FIG. 22 is a perspective view illustrating some components of the outer door from the front according to an embodiment of the present disclosure. FIG. 23 is a front view illustrating some components of the outer door according to an embodiment of the present disclosure. FIG. 24 is an enlarged perspective view illustrating region F in FIG. 23 from the rear in the outer door according to an embodiment of the present disclosure.

Hereinafter, for convenience of explanation, components substantially identical or similar to those described with reference to FIGS. 12 to 16 may be omitted or briefly described.

Referring to FIGS. 20 to 24, the first electric wire 531 according to an embodiment of the present disclosure may extend along a fourth section provided between the first corner 201 and the fourth corner 204, and a third section provided between the fourth corner 204 and the third corner 203 in the perimeter region S. In other words, the first electric wire 531, which has been withdrawn from the electric wire withdrawing portion 221d and withdrawn into the inside of the outer door 200, may be arranged to extend to the left along the perimeter of the outer door 200 and extend downward from the fourth corner 204.

The first electric wire 531 may be provided between the upper surface of the outer door 200 and an upper surface of the insulation panel 290 in the fourth section. The first electric wire 531 may extend frontward of a front surface of the third door cap 220 in the fourth section. The first electric wire 531 may extend toward the fourth corner 204 in the fourth section. The first electric wire 531 may be provided to be spaced apart from the insulation panel 290 in the fourth section.

The first electric wire 531 may be provided between the inner side surface of the outer door 200 and an outer side surface 291 of the insulation panel 290 in the third section. The first electric wire 531 may be arranged between an inner side surface 241 of the third side chassis 240 and the outer side surface 291 of the insulation panel 290 in the third section. The first electric wire 531 may extend downward in a substantially vertical direction in the third section. Accordingly, the first electric wire 531 may be prevented from interfering with the insulation panel 290 provided in the central portion. The first electric wire 531 may be spaced apart from the insulation panel 290.

As an example, the first electric wire 531 may be provided further outward than the second gasket mounting portion 262 provided on the outer edge of the second door liner 260 in the third section. The first electric wire 531 may be provided between the second gasket mounting portion 262 and the inner side surface 241 of the third side chassis 240 in the third section.

That is, the first electric wire 531 may be provided in the perimeter region S. Accordingly, the first electric wire 531 may not be provided to cross the insulation panel 290 of the central portion of the outer door 200. The first electric wire 531 may be provided to bypass the insulation panel 290 along the perimeter of the outer door 200. Accordingly, damage to the insulation panel 290 or deterioration of the insulation performance of the outer door 200 may be prevented.

In addition, the outer door 200 may be provided with an upper guide rib assembly 710 on the third door cap 220 of the outer door 200 as an electric wire fixing structure for upper wiring of the electric wire. The upper guide rib assembly 710 may be formed on the opposite side of the rotation axis R of the outer door 200, that is, near an upper edge of the door opening side. The upper guide rib assembly 710 may be provided at the fourth corner 204. The upper guide rib assembly 710 may perform a function of fixing the electric wire extending along the upper edge.

The upper guide rib assembly 710 may be composed of a first rib 711, a second rib 712, and a rib cap 713. The first rib 711 may be provided in a shape of being spaced apart from and extending parallel to the front surface of the upper door cap 220, and the second rib 712 may be provided in a shape of connecting one end of the first rib 711 to the front surface of the third door cap 220. Accordingly, a U-shaped first electric wire guide gap 714 may be formed between the first rib 711 and the front surface of the third door cap 220.

The first electric wire guide gap 714 may act as a passage capable of guiding an electric wire extending along the upper edge of the inside of the outer door 200. The electric wire may be inserted and arranged between the first rib 711 and the front surface of the third door cap 220, and the rib cap 713 may fix the electric wire to prevent from being deviated from the inside by connecting a free end of the first rib 711 and the front surface of the third door cap 220 to completely close the first electric wire guide gap 714.

After the rib cap 713 may be integrally injection-molded with the third door cap 220, a thin connecting member 713c may be cut off, separated, and reassembled. The rib cap 713 may include a coupling groove 713b or a coupling protrusion, etc., which may be assembled by being fitted into an end of the first rib 711 or a corresponding portion of the third door cap 220.

Through the upper guide rib assembly 710 as described above, the electric wire arranged along the upper edge may be stably fixed, thereby preventing the electric wire from being displaced or sagging even during an opening and closing operation of the outer door 200 or a foaming process. Additionally, the assembly process may be simplified as the rib structure is formed integrally in an injection molding process of the third door cap 220.

A refrigerator 1 according to the present disclosure may include a main body 10 having a storage compartment 21, a door 200 configured to be rotatable on the main body 10 to open and close the storage compartment 21, a sensor unit 400 provided on a lower portion of the door 200 to recognize external information, and an electric wire 500 electrically connected to the sensor unit 400 by being withdrawn from the main body 10 and passing through the inside of the door 200, wherein the door 200 may include an insulation panel 290 provided on a central portion inside the door 200, a perimeter region S provided inside the door 200 to be provided along a perimeter of the door 200 on the outside of the insulation panel 290, and an electric wire fixing part 600 provided to guide the electric wire 500 to be bent at a corner of the perimeter region S and extend along the perimeter region.

The door 200 may include a front plate 210 forming a front surface of the door 200, a rear plate 280 provided on a rear side of the insulation panel 290 to form a rear surface of the door 200, a door liner 260 forming a portion of the rear surface of the door 200, a plurality of side chassis 240 and 250 forming opposite side surfaces of the door 200, an upper door cap 220 forming an upper surface of the door 200, and a lower door cap 230 forming a lower surface of the door 200, wherein the front plate 210, the rear plate 280, the door liner 260, the plurality of side chassis 240 and 250, the upper door cap 220, and the lower door cap 230 may form an accommodating space provided inside the door 200, and the insulation panel 290 and the perimeter region S may be provided in the accommodating space.

The electric wire 500 may be arranged to be bent on the electric wire fixing part 600 and to extend along a first section provided from the electric wire fixing part 600 toward one side in a perimeter direction of the door 200 and a second section provided from the electric wire fixing part 600 toward the other side in the perimeter direction of the door 200.

The electric wire 500 extended in the first section may be positioned between the outside of the door 200 and the electric wire fixing part 600, and the electric wire 500 extended in the second section may be positioned between the electric wire fixing part 600 and the sensor unit 400.

The electric wire 500 may be provided to be disposed between inner side surfaces of the side chassis 240 and 250 and outer side surfaces of the insulation panel 290.

The electric wire fixing part 600 may be provided on one side of the lower door cap 230 adjacent to a rotation axis R of the door 200 and may include a lower guide rib 610 formed to protrude in an inside direction of the door 200 from the lower door cap 230.

The lower guide rib 610 may be spaced apart from a wall of the lower door cap 230 to form a first electric wire guide gap 620, and the electric wire 500 may be provided to be fixed in the first electric wire guide gap 620.

An outer side surface of the lower guide rib 610 may include a flat portion 611 provided to face the wall forming the first electric wire guide gap 620 and a curved portion 612 provided on the opposite side of the flat portion 611.

The lower guide rib 610 may include a fastening hole open toward a lower side of the lower door cap 230 so that a screw is fastened on the lower side of the lower door cap 230.

The electric wire fixing part 600 may be provided on a side opposite to one side of the upper door cap 220 adjacent to the rotation axis R of the door 200 and may include an upper guide rib assembly 710 provided to form a first electric wire guide gap 714 with one surface of the upper door cap 220.

The upper guide rib assembly 710 may include a first rib 711 extending to be spaced apart from a front surface of the upper door cap 220, a second rib 712 provided to connect one end of the first rib 711 and the front surface of the upper door cap 220, and a rib cap 713 provided to be assembled to the other end of the first rib 711 to cover a gap between the other end of the first rib 711 and the front surface of the upper door cap 220.

The electric wire 500 may be fixed between the first rib 711 and the front surface of the upper door cap 220.

The rib cap 713 may be integrally injected with the upper door cap 220 and then separated and assembled to the other end of the first rib 711.

The refrigerator may further include an inner door 100 rotatably provided in the front of the main body 10 and including an opening 101, and a hinge 850 provided on the inner door 100 to be rotatably coupled to the door 200, the hinge 850 including a hinge plate 852 coupled to the inner door 100 and having a passing hole 852a of a closed shape formed therein so that the electric wire 500 passes therethrough in an up-down direction, and a hinge shaft 851 inserted into an insertion hole 221a communicating with the inside of the door 200, wherein the door 200 may include an outer door 200 rotatably provided in front of the inner door 100 to open and close the opening 101.

A shaft groove 851a extending in a shaft direction to an end of the hinge shaft 851 may be formed on an outer circumferential surface of the hinge shaft 851 so that the electric wire 500 passed through the passing hole 852a may be provided to be withdrawn into the inside of the outer door 200 along the shaft groove 851a.

A refrigerator 1 according to the present disclosure may include a main body 10 having a storage compartment 21, an inner door 100 rotatably coupled to the front of the main body 10 and including an opening 101, and an outer door 200 rotatably coupled to the front of the inner door 100 to open and close the opening 101, wherein the outer door 200 may include an insulation panel 290 disposed on a central portion inside the outer door 200, a perimeter region S provided on an outer side of an edge of the insulation panel 290 along a perimeter of the outer door 200, an electric wire 500 arranged to extend along the inside of the outer door 200 to be electrically connected to a sensor unit 400 disposed on a lower portion of the outer door 200, and an electric wire fixing part 600 provided to guide the electric wire 500 to be bent at a corner of the perimeter region S and extend along the perimeter region, and the electric wire 500 may be provided to bypass the insulation panel 290 and extend along the perimeter region S.

The outer door 200 may include a front plate 210 forming a front surface, a rear plate 280 forming a rear surface, a door liner 260 forming the rear surface, a plurality of side chassis 240 and 250 forming opposite side surfaces, an upper door cap 220 provided to cover an upper surface, and a lower door cap 230 provided to cover a lower surface, the front plate 210, the rear plate 280, the plurality of side chassis 240 and 250, the upper door cap 220, and the lower door cap 230 may form an accommodating space inside the outer door 200, and the insulation panel 290 and the perimeter region S may be disposed in the accommodating space.

The electric wire 500 may be withdrawn into the inside of the outer door 200 and arranged sequentially along a first section extending to one side of the door 200 along a perimeter of the door 200 and a second section extending along a perimeter of the door 200 from one side of the door 200 to the sensor unit 400, and the electric wire 500 may be bent on and extend from the electric wire fixing part 600 provided between the first section and the second section.

The electric wire fixing part 600 may include a lower guide rib 610 formed to protrude from one side of the lower door cap 230 adjacent to a rotation axis R of the outer door 200, and the electric wire 500 may be arranged between an inner side surface of the side chassis 240 and 250 of the outer door 200 and an outer side surface of the insulation panel 290 in the first section.

A refrigerator 1 according to the present disclosure may include a main body 10 having a storage compartment 21, a double door including an inner door 100 and an outer door 200 rotatably coupled to each other through a hinge 850, and a sensor unit 400 coupled to a lower portion of the outer door 200 to recognize external information, wherein the hinge 850 may include a hinge plate 852 fixed to the inner door 100 and a hinge shaft 851 rotatably inserted into an insertion hole 221a of the outer door 200, a passing hole 852a of a closed shape through which an electric wire 500 penetrates in an up-down direction may be formed in the hinge plate 852, and a shaft groove 851a extending to an end of the hinge shaft 851 may be formed on an outer circumferential surface of the hinge shaft 851, so that the electric wire 500 may pass through the passing hole 852a, be withdrawn into the inside of the outer door 200 along the shaft groove 851a, extend along a perimeter region S of the outer door 200, pass through the inside of the outer door 200, and be electrically connected to the sensor unit 400.

According to the present disclosure, because an electric wire passed through the inside of a door is connected to a sensor unit provided on the door, the arrangement of the electric wire can be facilitated.

According to the present disclosure, because a wire fixing part is provided in a refrigerator to fix the electric wire passing the inside of the door, the electric wire cannot come into contact with a vacuum insulation panel.

According to the present disclosure, because the electric wire is arranged to bypass the vacuum insulation panel inside the door, exterior protrusion of the door or deterioration of the insulation function due to the electric wire can be prevented.

Effects according to the present disclosure are not limited to the effects mentioned above, and other effects not mentioned will be clearly understood by those skilled in the art to which the present disclosure belongs from the fallowing description.

The foregoing has illustrated and described specific embodiments. However, it should be understood by those of skilled in the art that the present disclosure is not limited to the above-described embodiments, and various changes and modifications may be made without departing from the technical idea of the present disclosure described in the following claims and their equivalents.

What is claimed is:

1. A refrigerator comprising:
a main body having a storage compartment;
a door configured to be rotatable with respect to the main body to open or close the storage compartment;
a controller included in the main body, and configured to control the door to open or close;
a sensor disposed at a lower portion of the door to detect external information and transmit a signal including the detected external information to the controller so that the controller controls the door to open or close based on the transmitted signal; and
an electric wire electrically connected to the sensor and the controller, respectively, to transmit the signal to the controller, the electric wire being withdrawn from the main body and passing through inside of the door,
wherein the door comprises:
an accommodating space therein;
an insulation panel disposed in the accommodating space;
a perimeter region included in the accommodating space, and formed between an outer side of the insulation panel and an inner side of the door along a perimeter of the door; and
an electric wire fixing part to guide the electric wire to be bent at a corner of the perimeter region and extend along the perimeter region.

2. The refrigerator according to claim 1, wherein
the door further comprises:
a front plate forming a front surface of the door;
a rear plate forming a rear surface of the door, the insulation panel disposed between the front plate and the rear plate;
a door liner forming a portion of the rear surface of the door;
a plurality of side chassis forming opposite side surfaces of the door;
an upper door cap forming an upper surface of the door; and
a lower door cap forming a lower surface of the door, and
wherein the accommodating space is formed by the front plate, the rear plate, the door liner, the plurality of side chassis, the upper door cap, and the lower door cap.

3. The refrigerator according to claim 1, wherein
the electric wire is arranged to be bent on the electric wire fixing part and to extend along a first section of the perimeter region from the electric wire fixing part toward one side in a perimeter direction of the door and a second section of the perimeter region from the electric wire fixing part toward an other side in the perimeter direction of the door.

4. The refrigerator according to claim 3, wherein
the electric wire extended in the first section is positioned between outside of the door and the electric wire fixing part, and
the electric wire extended in the second section is positioned between the electric wire fixing part and the sensor.

5. The refrigerator according to claim 2, wherein
the electric wire is disposed between inner side surfaces of the plurality of side chassis and outer side surfaces of the insulation panel.

6. The refrigerator according to claim 2, wherein
the electric wire fixing part is on one side of the lower door cap adjacent to a rotation axis of the door, and comprises a lower guide rib formed to protrude in an inside direction of the door from the lower door cap.

7. The refrigerator according to claim 6, wherein
the lower guide rib is spaced apart from a wall of the lower door cap to form a first electric wire guide gap, and
the electric wire is fixed in the first electric wire guide gap.

8. The refrigerator according to claim 7, wherein
an outer side surface of the lower guide rib comprises:
a flat portion to face the wall forming the first electric wire guide gap; and
a curved portion disposed on an opposite side of the flat portion.

9. The refrigerator according to claim 7, wherein
the lower guide rib comprises:
a fastening hole open toward a lower side of the lower door cap so that a screw is fastened on the lower side of the lower door cap.

10. The refrigerator according to claim 2, wherein
the electric wire fixing part is on a side opposite to one side of the upper door cap adjacent to a rotation axis of the door, and comprises an upper guide rib assembly to form a first electric wire guide gap with one surface of the upper door cap.

11. The refrigerator according to claim 10, wherein
the upper guide rib assembly comprises:
a first rib extending to be spaced apart from a front surface of the upper door cap;
a second rib to connect one end of the first rib and the front surface of the upper door cap; and
a rib cap to be assembled to an other end of the first rib to cover a gap between the other end of the first rib and the front surface of the upper door cap.

12. The refrigerator according to claim 11, wherein
the electric wire is fixed between the first rib and the front surface of the upper door cap.

13. The refrigerator according to claim 11, wherein
the rib cap is integrally injected with the upper door cap and then separated and assembled to the other end of the first rib.

14. The refrigerator according to claim 1, further comprising:
an inner door configured to be rotated in a front of the main body, the inner door comprising an opening; and
a hinge disposed on the inner door to be rotatably coupled to the door, the hinge comprising:
a hinge plate coupled to the inner door and having a passing hole of a closed shape formed therein so that the electric wire passes therethrough in an up-down direction; and
a hinge shaft inserted into an insertion hole communicating with the inside of the door,
wherein the door further comprises an outer door configured to be rotated in front of the inner door to open or close the opening.

15. The refrigerator according to claim 14, wherein
a shaft groove extending in a shaft direction to an end of the hinge shaft is formed on an outer circumferential surface of the hinge shaft so that the electric wire passed through the passing hole is to be withdrawn into the inside of the outer door along the shaft groove.

16. A refrigerator comprising:
a main body having a storage compartment;
a double door configured to be rotatable with respect to the main body to open or close the storage compartment, the double door comprising:
an outer door;
an inner door rotatably coupled to the outer door;
a controller included in the main body, and configured to control the double door to open or close;
a sensor coupled to a lower portion of the outer door to detect external information and transmit a signal including the detected external information to the controller so that the controller controls the double door to open or close based on the transmitted signal;
an electric wire electrically connected to the sensor and the controller, respectively, to transmit the signal to the controller,
wherein
the outer door including:
a hinge insertion hole;
an accommodating space therein;
an insulation panel disposed in the accommodating space;
a perimeter region included in the accommodating space, and formed between an outer side of the insulation panel and an inner side of the outer door along a perimeter of the outer door; and
an electric wire fixing part to guide the electric wire to be bent at a corner of the perimeter region and extend along the perimeter region, and
the inner door including a hinge to be rotatably coupled to the outer door, the hinge including:
a hinge plate coupled to the inner door and having a passing hole for the electric wire to pass therethrough; and
a hinge shaft rotatably inserted into the hinge insertion hole to communicate with inside of the outer door so that the electric wire from the controller passes through the passing hole, extends along the perimeter region of the outer door, passes through the inside of the outer door, and be electrically connected to the sensor.
